(19) United States
(12) Patent Application Publication
(10) Pub. No.: US 2007/0272066 A1
(43) Pub. Date: Nov. 29, 2007

(54) Power Tool and Components Therefor

(76) Inventors: William J. Phillips, Bolingbrook, IL (US); William P. Curry, Hampshire, IL (US)

Correspondence Address: FITCH EVEN TABIN AND FLANNERY, 120 SOUTH LA SALLE STREET, SUITE 1600, CHICAGO, IL, 60603-3406, US

(21) Appl. No.: 11/619,933

(22) Filed: Jan. 4, 2007

Related U.S. Application Data
(63) Continuation of application No. 10/944,165, filed on Sep. 17, 2004, now abandoned.
(60) Provisional application No. 60/503,680, filed on Sep. 17, 2003.

(51) Int. Cl. B27B 5/16

(52) U.S. Cl. 83/435.11

(57) ABSTRACT

A power tool and components and accessories therefor are provided. The power tool having at least one of a movable extension member, a retractable handle, a retractable workpiece support, a modular base, a digital display, a display connected to a table, a miter gauge with passing angle setting assembly, a fence with a handle operable to both move the fence and secure it in position, a retractable rail, an electrical outlet, and leg extensions.

### CROSS REFERENCE TO RELATED APPLICATION

This application is a Continuation of U.S. patent application Ser. No. 10/944,165, filed Sep. 17, 2004, which claimed the benefit from U.S. Provisional Patent Application No. 60/503,680, filed Sep. 17, 2003, which is hereby incorporated herein by reference in its entirety.

### FIELD OF THE INVENTION

This invention relates generally to a power tool and, more particularly, to a table saw and components therefor.

### BACKGROUND OF THE INVENTION

Traditional power tools are often too large or awkwardly shaped to allow the tool to be conveniently moved from one work site to another. This is particularly true with respect to table saws, which are either provided in a bench top table saw configuration or a stationary table saw configuration. Although bench top table saw configurations are somewhat compact, they tend to sacrifice several desirable features in order to maintain their compact size. For example, bench top table saws lack sufficient table extensions and workpiece supports to enable the bench top table saw to more easily accommodate larger workpieces. These tools also do not accommodate the operator's need to work with varying sizes of workpieces. For instance, some tools may provide additional workpiece supports for handling longer workpieces, but they do not allow the operator to reconfigure the tool to work with wider workpieces, and vice versa. In addition, bench top table saws are often difficult to grasp and carry from one site to another.

Another shortcoming associated with table saws today is their inability to provide operators with easy and accurate mechanisms that detect and adjust the height and angle of the saw blade. Table saws may also lack bases that provide the operator with useful features and which simplify the manufacture of, and the inventory of components necessary to manufacture, such tools. In addition to these shortcomings, the table saws of today require use of accessories, such as fences and miter gauges, which do not help the operator as much as they could in positioning and/or feeding the workpiece into the blade. More particularly, the fences and miter gauges currently available do not assist the operator in routine activities which are done with the table saw.

The table saws of today also lack features which increase the flexibility and portability of the table saws. For example, the table saws generally are of the bench top type or stationary freestanding type, but do not provide for the conversion of one type of table saw to the other as circumstances require. That is, bench top table saws generally cannot be converted to be used as a stationary freestanding table saw if a bench top is unavailable at the work site and vice versa. Likewise, the electrical cords attached to table saws have been found to be problematic, as the relatively short length often necessitates the use of extension cords to extend the cord to the nearest outlet at a work site, while this same cord is generally long enough to interfere with the shifting of the table saw from one location to another, either due to the inability to coil the cord around the saw or the possibility that the operator may trip over or step on the cord during transit, increasing the likelihood of injury to the operator and damage to the saw. Additionally, other accessories which increase the convenience of or ease of use of the table saw at the work site have been found lacking.

Accordingly, it has been determined that the need exists for an improved power tool and components therefor which overcomes the aforementioned limitations and which further provides capabilities, features and functions, not available in current bases and methods, and for an improved method for doing the same.

### BRIEF DESCRIPTION OF THE DRAWINGS

FIGS. 1A-B are perspective views of a power tool embodying features of the present invention, the figures illustrating an extension portion in the non-use and use positions, respectively;

FIGS. 2A-D are perspective views of an alternate embodiment of a power tool embodying features of the present invention showing an additional extension member and both extension members in a plurality of interchangeable positions;

FIG. 3 is an enlarged perspective view of the incremental blade height indicator as illustrated in FIGS. 2A-D;

FIG. 4 is partial cross-sectional view of the incremental blade height indicator of FIG. 3;

FIGS. 5A-B are perspective views of an alternate embodiment of a power tool embodying features of the present invention, the figures illustrating an alternate extension member in a plurality of interchangeable positions;

FIGS. 6A-B are perspective views of an alternate embodiment of a power tool embodying features of the present invention, the figures illustrating a slidable table extension in stored and extended positions, respectively;

FIGS. 6C-D are front elevational and plan views, respectively, of the embodiment of FIGS. 6A-B;

FIGS. 6E-G are partially exploded views of the embodiment of FIGS. 6A-B;

FIGS. 7A-B are perspective views of a base for a power tool embodying features of the present invention, the figures illustrating fence and miter gauge supports without and with a fence and miter gauge, respectively;

FIGS. 7C-D are perspective views of alternate side panels for a power tool base embodying features of the present invention;

FIGS. 8A-B are perspective and cross-sectional views, respectively, of a miter gauge embodying features of the present invention including a passive angle setting assembly;

FIGS. 9A-B are perspective views of a fence embodying features of the present invention, the fence having a single handle for both positioning and securing the fence to the rails;

FIGS. 9C-D are side elevational views of the fence of FIGS. 9A-B showing the fence handle in fence release and fence securing positions, respectively;

FIGS. 9E-F are cross-sectional views of the fence of FIGS. 9C-D, showing the fence handle in fence releasing and fence securing positions, respectively;

FIG. 9G is a perspective cut away view of the fence of FIGS. 9A-B showing the relationship between handle rotation and fence movement;

FIGS. 9H-I are enlarged views of the first end portion of an alternate fence, showing the handle in fence releasing and fence securing positions, respectively;

FIGS. 10A-B are perspective views of fence rails embodying features of the present invention, the figures illustrating foldable rail portions in extended and stored positions, respectively;

FIGS. 10C-D are perspective views of the fence rails of FIGS. 10A-B showing the foldable rail portions in the extended position but detached from the remainder of their respective rails;

FIG. 10E is a perspective view of the fence rails of FIGS. 10A-B showing the foldable rail portions in the extended position but detached from the remainder of their respective rails;

FIG. 10F is a cross-sectional view of the rail and foldable rail portion of FIGS. 10A-B showing the internal nut fixed to the foldable rail portion;

FIG. 10G is a cross sectional view of the table extension and foldable rail portion of FIGS. 1A-B showing the shoulder bolt assembly that allows the foldable rail to be slidingly moved with respect to the table extension.

FIG. 11A is a perspective view of an alternate embodiment of a power tool embodying features of the present invention, the figures illustrating leg extension accessories which may be attache to the power tool;

FIG. 11B is an elevational view of the power tool of FIG. 11A;

FIG. 11C is an exploded perspective view of the power tool of FIG. 11A;

FIG. 11D is an enlarged view of the right side portion of the power tool of FIG. 11A, showing a leg extension accessory exploded from the power tool;

FIG. 11E is an enlarged view of the front right corner of the power tool of FIG. 11A, showing the leg extension accessory attached to the corner post of the power tool.

FIGS. 12A-B are perspective and top plan views of an alternate power tool embodying features of the present invention, the figures illustrating an external cord storage system accessory for the power tool;

FIGS. 13A-B are perspective views of an alternate power tool embodying features of the present invention, the figures illustrating an internal cord storage system accessory for the power tool;

FIGS. 14A-B are perspective views of an alternate power tool embodying features of the present invention, the figures illustrating an electrical outlet accessory and an removable cord storage accessory for the power tool;

FIG. 15 is a perspective view of an alternate power tool embodying features of the present invention, the figures illustrating an audio accessory for the power tool.

### DETAILED DESCRIPTION OF THE PREFERRED EMBODIMENT(S)

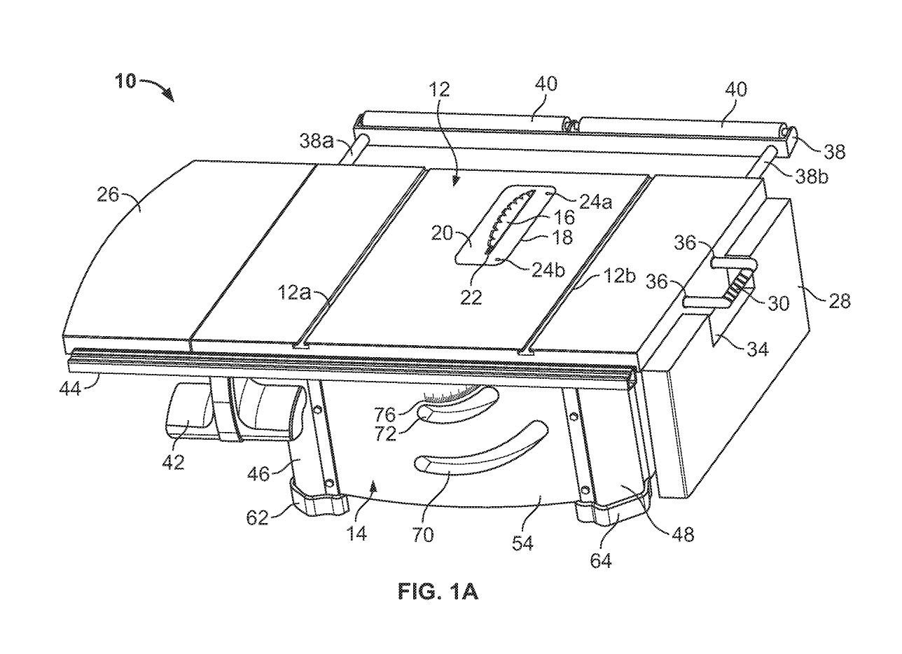

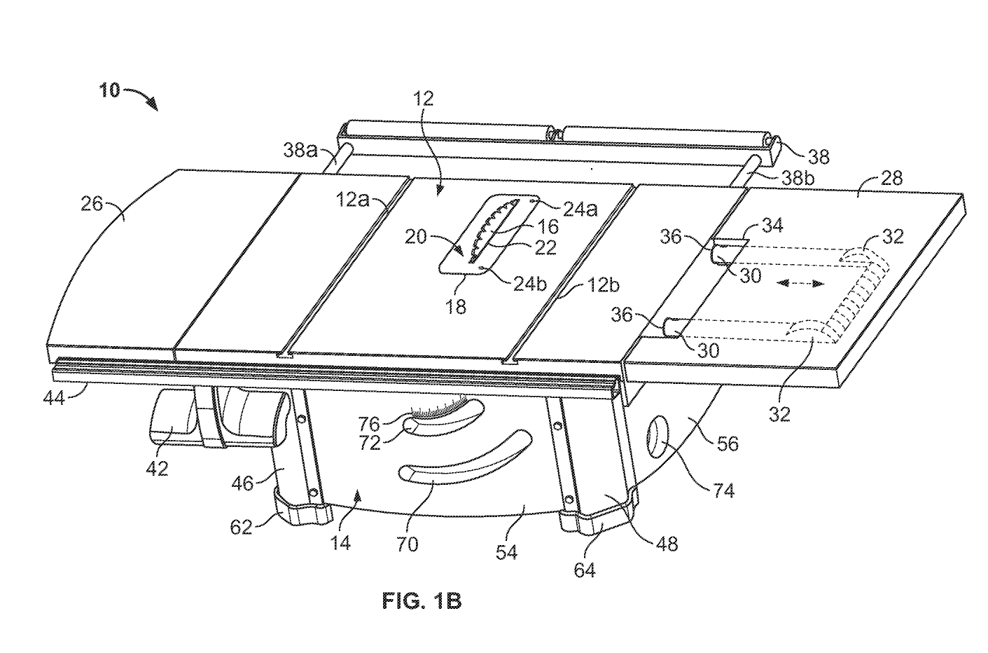

An exemplary power tool in accordance with the invention comprises an apparatus for cutting a workpiece. In one form, the apparatus comprises a table saw 10, as illustrated in FIGS. 1A-B, which includes a workpiece support surface, such as table 12, a base 14 for supporting the table 12, and a cutting implement, such as blade 16. The table 12 forms a generally flat surface upon which a workpiece, such as a wood board, may be positioned and fed into the blade 16 to make desired cuts therein. The table 12 is generally rectangular in shape and defines an opening 18 in which the blade 16 and an access panel or insert 20, are disposed. The access panel 20 defines an opening 22 through which at least a portion of the blade 16 is disposed and is removable from the table 12 to provide access to the blade 16 for purposes of servicing, removing and/or replacing the cutting implement. More particularly, the access panel 20 is connected to the table 12 via fasteners, such as adjustment screws 24a-b, which allow the panel 20 to be moved with respect to the table 12 so that the upper surface of the panel 20 may be made flush with the upper surface of the table 12. In one form, the table 12 also defines guides, such as T-slots 12a-b, which may be used with table saw accessories, such as miter gauges, for aligning the workpiece into a desired position for cutting.

In a preferred form, the table 12 has extension portions 26 and 28, which provide additional workpiece supporting surfaces for the table saw 10. In the embodiment illustrated in FIGS. 1A-B, the extension panel 26 is fixed in a workpiece support position and extension portion 28 is movable between a first position wherein the portion 28 is extended into a work supporting position (FIG. 1B) and a second position wherein the extension 28 is oriented into a stored position (FIG. 1A). Extension portion 28 is folded between the first and second position and is supported in the first position via a brace, such as retractable handle 30. More particularly, in FIG. 1A, the handle 30 is retracted and the extension 28 is folded into the stored position. In FIG. 1B, the extension 28 is extended into the workpiece support position, and the handle 30 is extended to brace the extension 28 in position.

To further secure the extension 28 into the workpiece support position, the extension 28 may be provided with a brace engaging member, such as handle recess 32, to secure the brace with respect to the extension 28. In the embodiment illustrated, the handle recess 32 is located in the lower surface of the extension 28 and secures the handle 30 to the extension 28 once the handle 30 has been extended to a predetermined length. In a preferred embodiment, the handle recess 32 is located at the distal end of the extension 28 in order to provide maximum support thereto. Thus, the handle 30 serves as a support beam for the extension 28 which can be locked into the workpiece support position.

As illustrated in FIG. 1B, the extension 28 may also define an opening or cutout 34 which allows an operator to more easily grasp the handle 30 when the extension 28 is located in the stored position, as illustrated in FIG. 1A. The handle 30 may then be used to carry or transport the table saw 10 from job site to job site. In the embodiment shown, the handle 30 may be extended or retracted with or without the extension 28 located in the first position so that the desired handle length may be obtained when moving or positioning the table saw 10. However, it should be understood that the apparatus 10 may be provided with a means for securing the handle 30 into the extended and/or retracted position. For example, the handle 30 and corresponding receiving slot 36 defined by table 12 may be designed with a frictional engagement so that the handle 30 remains in whatever position it is moved to. Alternatively, fasteners such as set screws may be provided for locking the handle into a desired position. In yet other embodiments, the handle 30 and table 12 may be designed with mating members, such as depressable clips or ball and detent mechanisms, that releasably lock the handle 30 into desired positions.

The apparatus 10 may also include an additional workpiece support member, such as support member 38, which provides additional table support when working with larger workpieces. In the embodiment illustrated in FIGS. 1A-B, the support 38 can be moved between an extended position wherein the support 38 is spaced from the table 12 to provide support for larger workpieces which overhang the apparatus 10 and a retracted position wherein the bar support 38 is located generally adjacent the table 12. The support 38 is connected to the table 12 via posts or rods 38a-b which allow the support to be shifted to a variety of positions. Similarly, the support 38 may be connected to the table 12 in a variety of fashions, such as a frictional engagement, fasteners, mating structures, or the like.

In a preferred form, the support 38 has rollers 40 which allow workpieces to be moved over the support 38 more easily. For example, in the embodiment illustrated in FIGS. 1A-B, the support 38 has two rollers, the uppermost surfaces of which are level with the upper surface of the table 12. In operation, the support 38 may be spaced from the table 12 by the desired amount so that the portions of the workpiece extending from the rear of table 12 (or overhanging portions) are supported by the rollers 40. Thus, as the workpiece is fed through the saw blade 16, the overhanging portions will be supported on the rollers 40 which will rotate to accommodate and/or assist movement of the workpiece.

A fence 42 may be connected to a guide, such as rail 44, in order to provide an end stop or wall with which the workpiece may be aligned for cutting. For example, fence 42 may be moved to a desired position along the length of rail 44 and then secured to the rail in order to form an upstanding wall extending from the front of the table saw 10 to the rear thereof. The workpiece is then positioned against the fence 42 and fed through the blade using the fence 42 to ensure that a straight and accurate cut is made thereto. In FIGS. 1A-B, fence 42 has been removed from the table 12 and rail 44 and stored on the base 14 below the table 12.

The base 14 illustrated in FIGS. 1A-B, comprises a modular structure having four corner posts 46, 48, 50 and 52 (hereinafter collectively referred to as “46-52”) interconnecting four side panels 54, 56, 58 and 60 (collectively “54-60”). In a preferred form, the posts 46-52 are made from metal, such as formed sheet metal, aluminum or steel, and the panels 54-60 are made from molded plastic. However, in alternate embodiments, the posts 46-52 and panels 54-60 may both be made from molded plastic or metal. In the embodiment illustrated, rubber feet 62, 64, 66 and 68 (collectively “62-68”) are connected to the lower portions of posts 46-52 to provide an enhanced frictional engagement with a support surface, such as a bench top or floor.

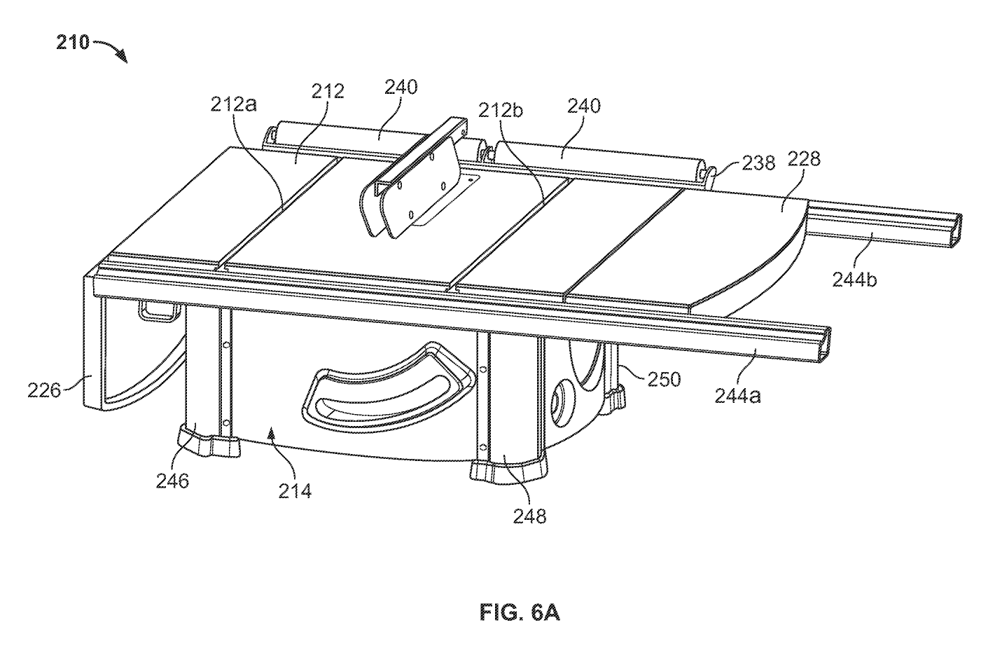

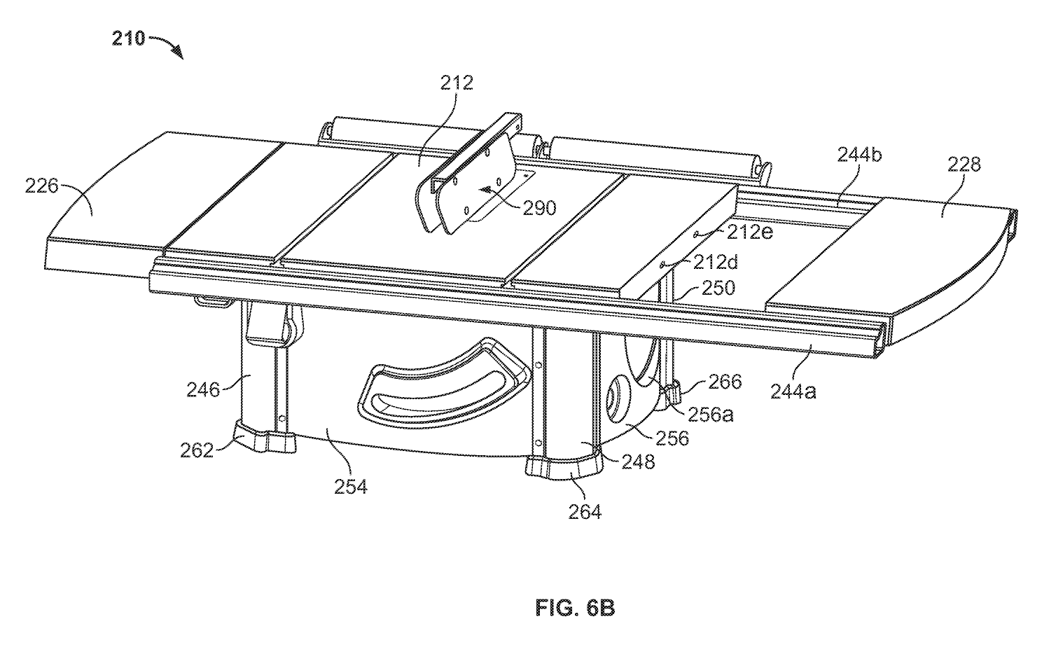

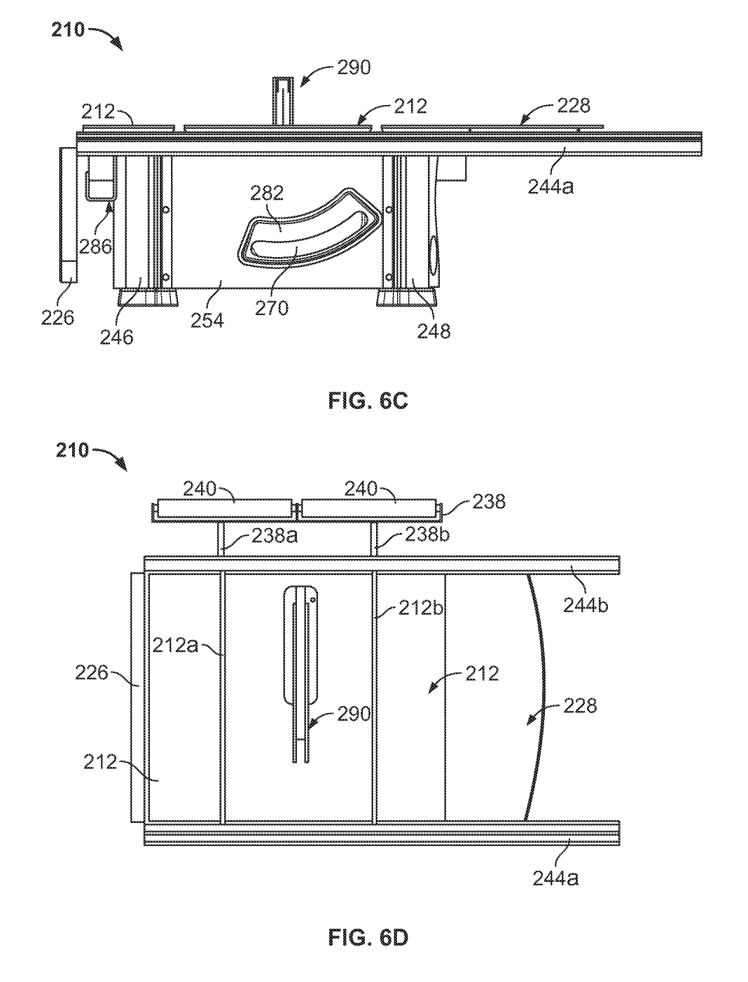

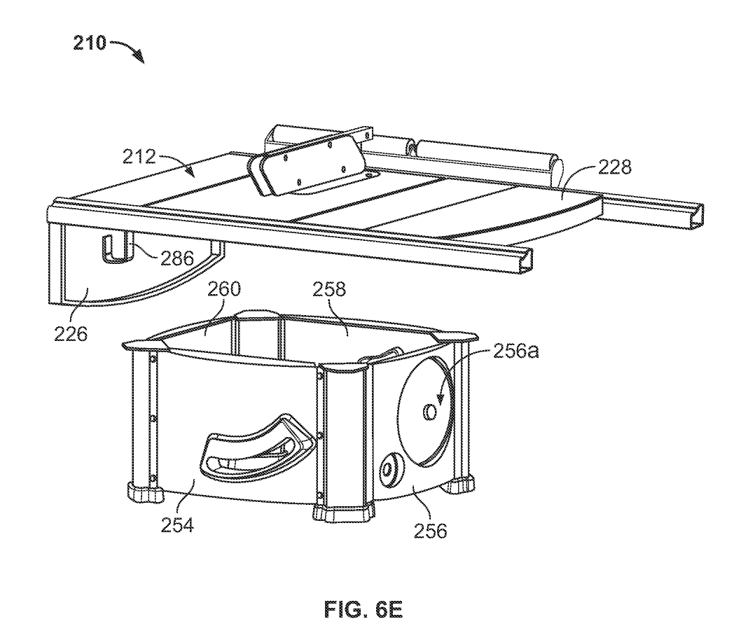

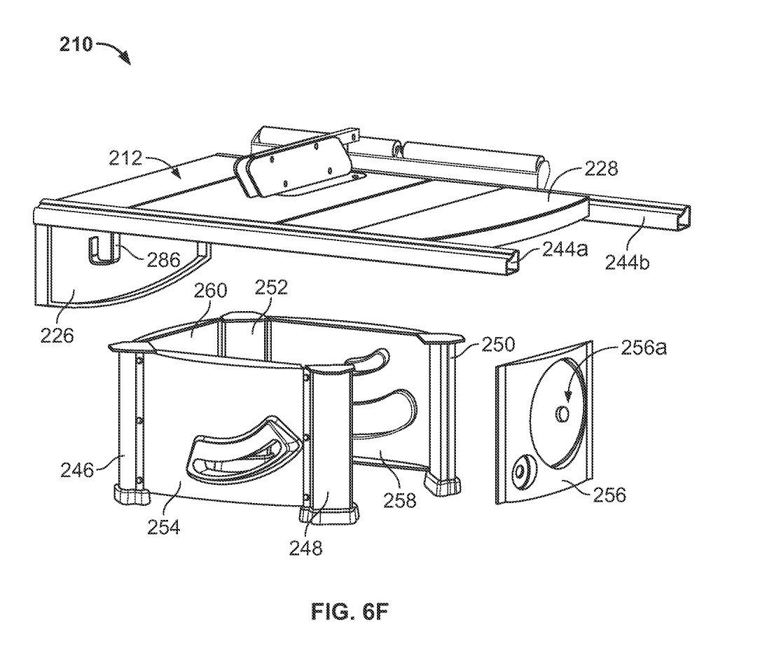

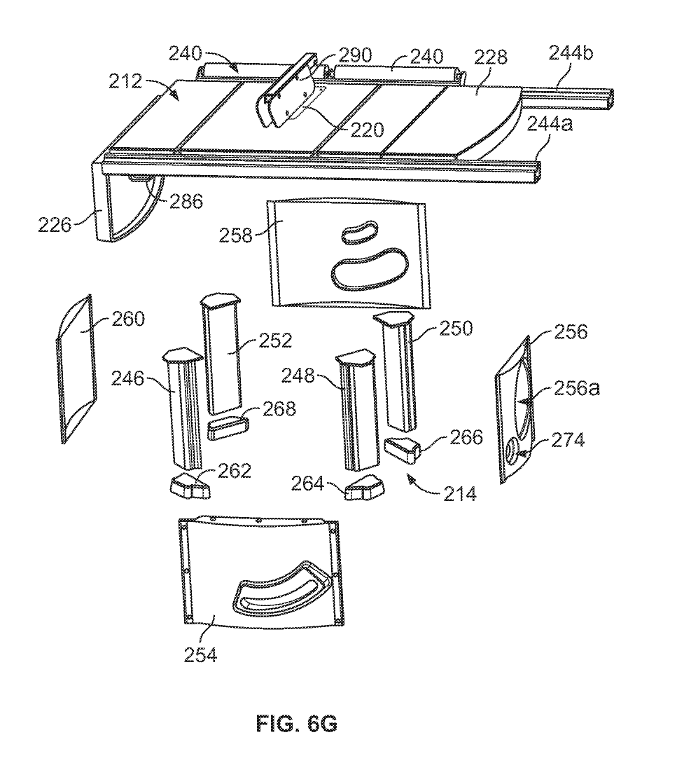

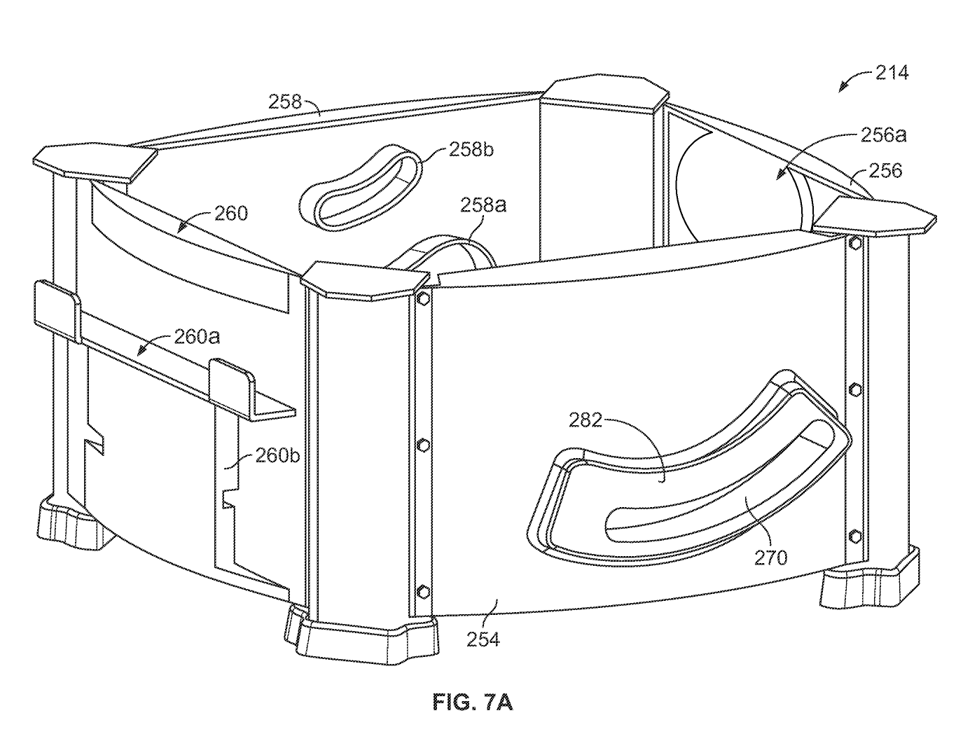

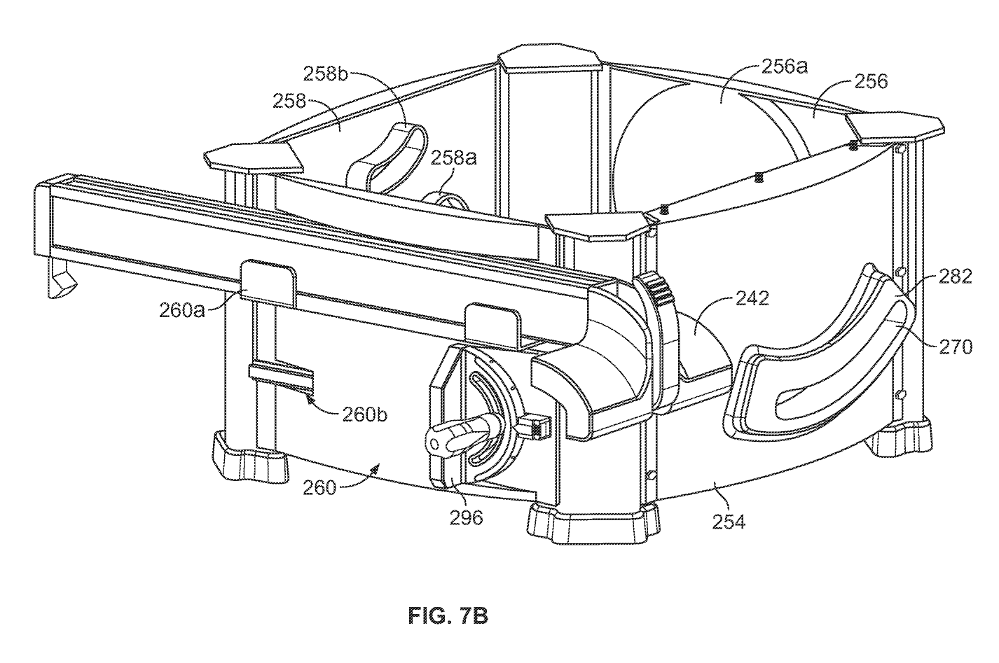

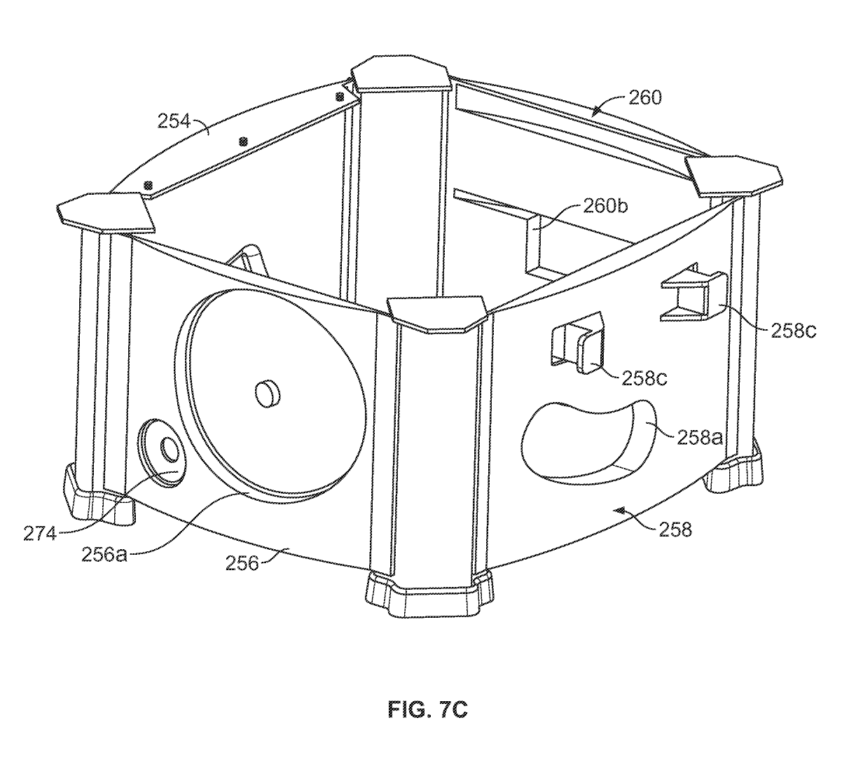

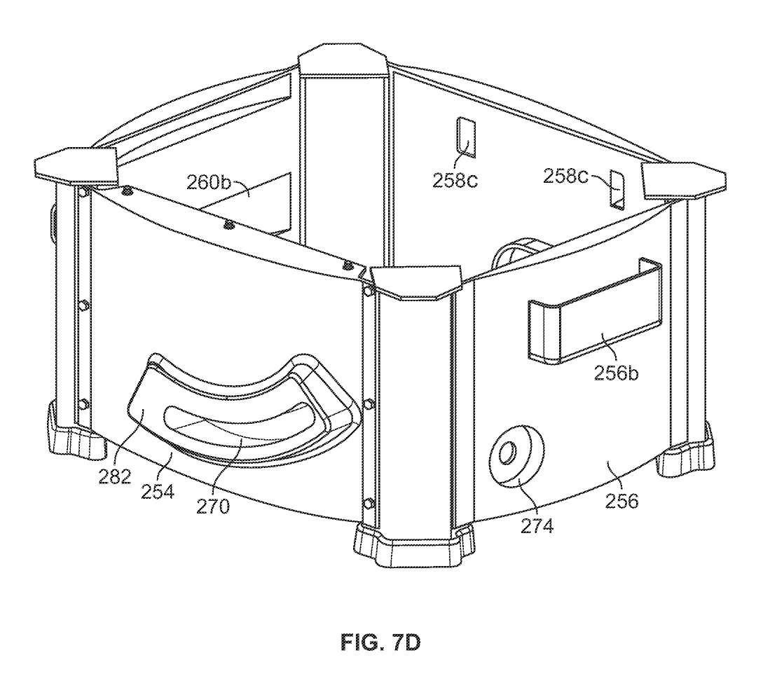

The posts 46-52 and feet 62-68 are preferably made interchangeable with their corresponding posts and feet in order to reduce costs associated with independent design, tooling and manufacturing needs and costs, inventory and so forth. For example, by using interchangeable posts 46-52, only one post needed to be designed, one set of tooling made, one type of post manufactured and one type of post kept in inventory. The panels 54-60 may also be designed to be at least partially interchangeable, however, the openings required for the blade height adjustment shaft in the front panel 54 and the blade angle adjustment shaft in the right side panel 56 will likely prevent these panels from being made interchangeable with the remaining side panels 58-60. It should be understood, however, that the configuration of the base 12 allows for such interchangeability and allows for replacement side panels to be purchased so that the power tool 10 can be upgraded and/or customized as the operator desires. Additional advantages of the modular construction of base 14 will be discussed further below with respect to FIGS. 6G and 7A-D.

In FIGS. 1A-B, panel 54 has a generally rectangular shape and has a convexly curved outer surface. In a preferred form, the thickness of panel 54 increases in the middle of the panel and tappers toward the end portions connected to posts 46-52 creating the curved appearance. The thickness of the panel also allows for additional accessories to be incorporated therewith and/or integrated therein, as will be discussed in greater detail below. As illustrated in FIGS. 1A-B, panel 54 defines two arcuate openings 70 and 72 to accommodate standard table saw height and angle adjustment mechanisms, respectively. More particularly, opening 70 allows for a traditional blade height adjustment shaft to extend out from the interior region of the table saw. A hand wheel or spindle is connected to the distal end of the blade height adjustment shaft so that an operator can raise or lower the cutting implement with respect to the upper surface of table 12. Opening 72 allows for a traditional blade angle indicator, such as a needle gauge, to extend from the interior region of the table saw.

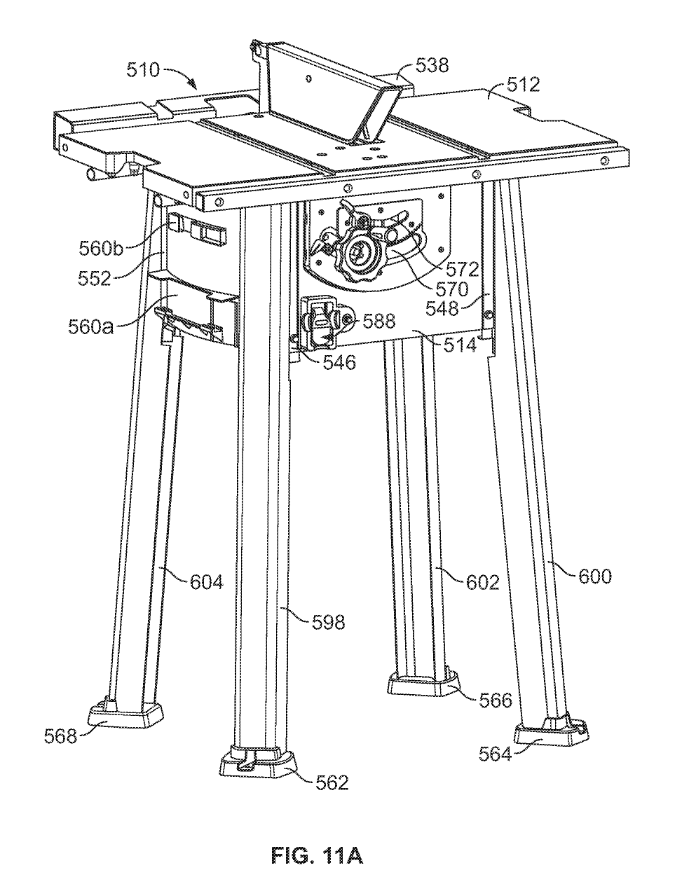

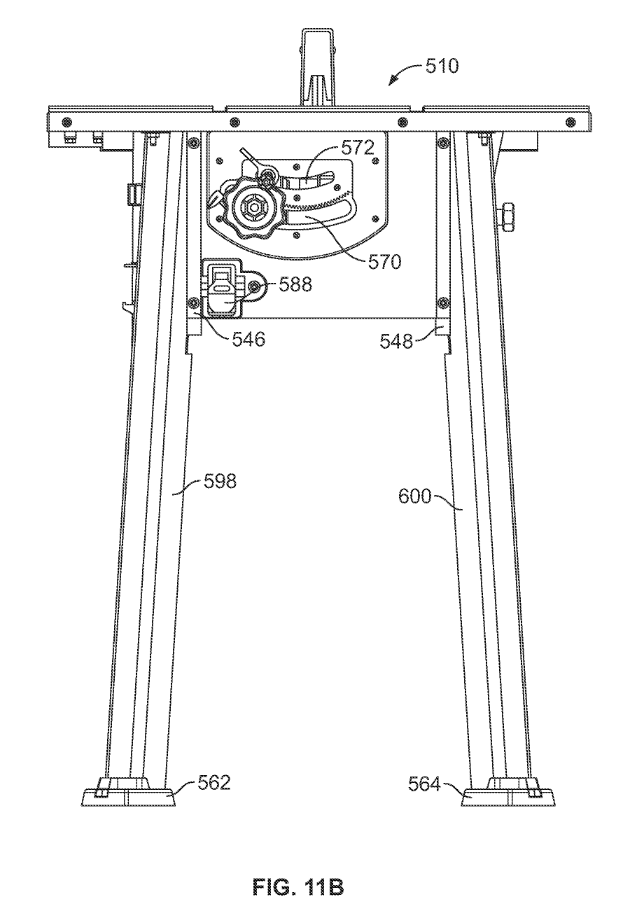

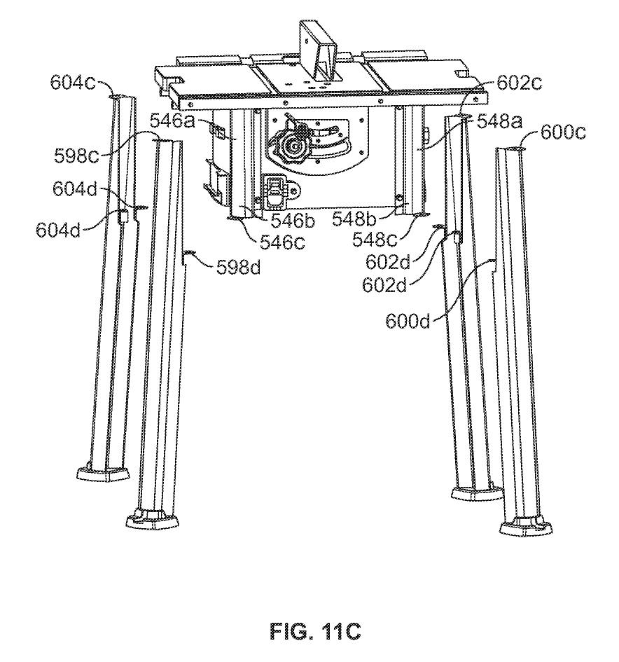

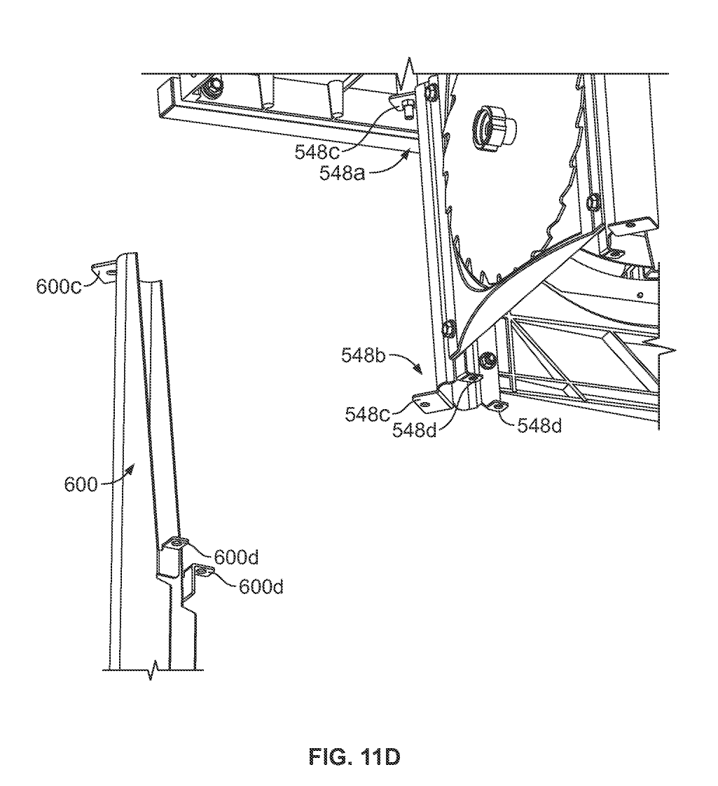

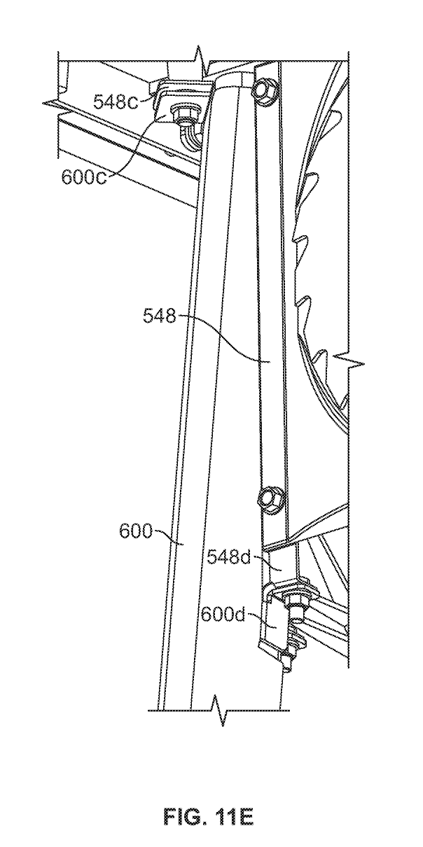

The openings 70 and 72 are arcuate in shape so that the blade height adjustment shaft and the blade angle or tilt indicator may move along with the blade 16 as the blade angle is adjusted. More particularly, a traditional blade angle adjustment shaft extends out from opening 74 in panel 56 (FIG. 1B) and is used to adjust the blade 16 from a position perpendicular to the upper surface of table 12 to a position angled with respect to the upper surface of table 12. In a preferred form, the blade 16 can be angled between 45° and 90° with respect to the upper surface of table 12. As the blade 16 is angled, the blade height adjustment shaft and blade angle indicator travel along the arcuate path of openings 70 and 72, with the blade angle indicator pointing to indicia, such as rulings 76, located about opening 72 to identify the current blade angle. It should be understood, however, that both the blade height adjustment shaft and blade angle indicator may extend from the same opening (e.g., opening 70), if desired, and alternate items, such as a blade angle locking shaft and knob, may extend from a second opening (e.g., opening 72) in the panels. In such an embodiment, the indicia 76 may be placed about the first opening 70, rather than the second opening 72, if desired. An example of such a configuration will be discussed in more detail with respect to FIGS. 11A-E below.

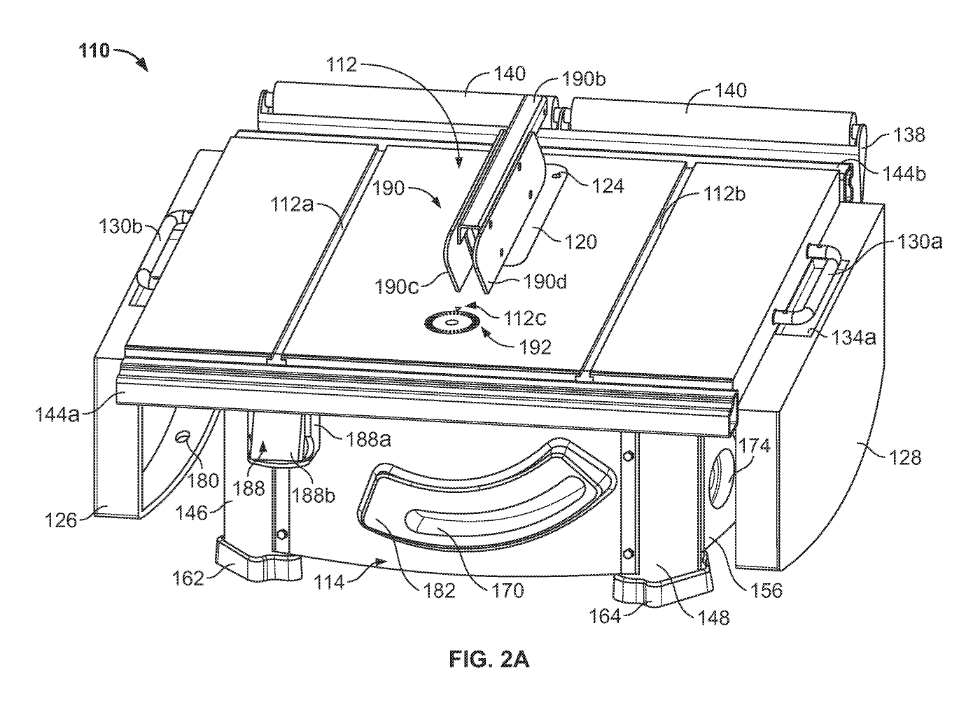

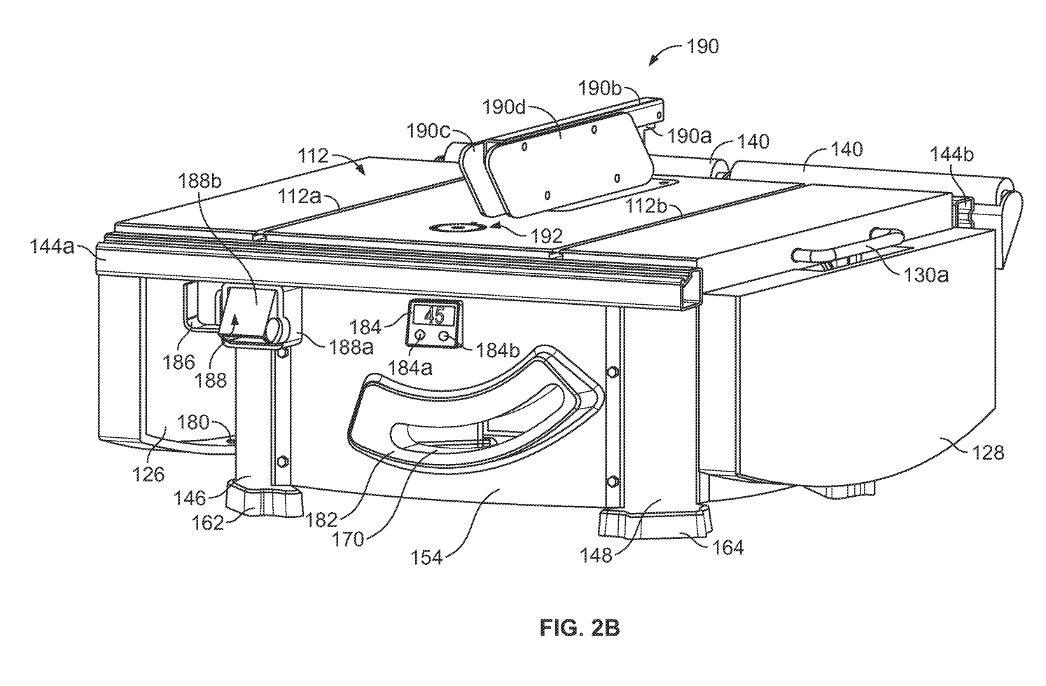

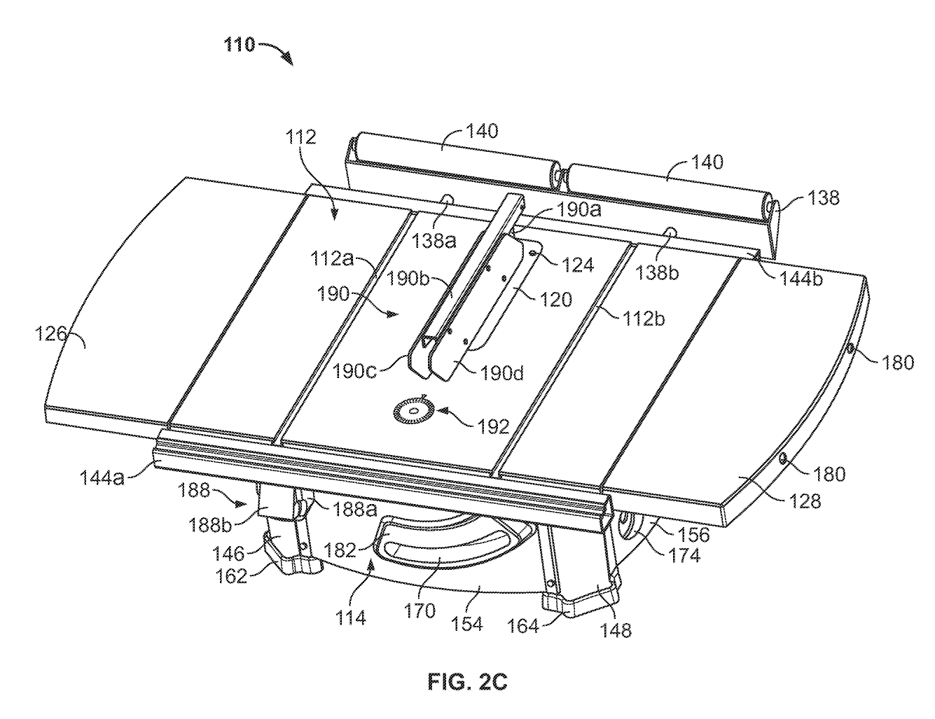

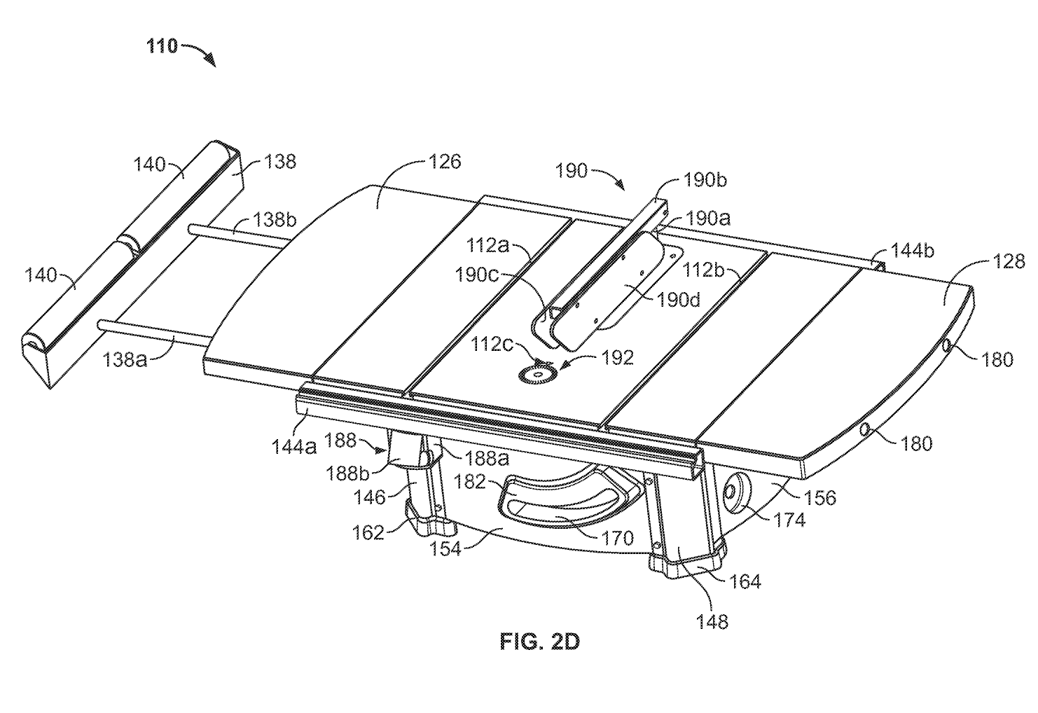

An alternate embodiment is disclosed in FIGS. 2A-D and is referred to generally by reference numeral 110. In these figures, parts which are similar to those previously discussed in FIGS. 1A-B are similarly numbered with the exception of having a prefix “1.” For example, table saw 110 of FIGS. 2A-D has a table 112 and base 114 which are similar to the table 12 and base 14 from FIGS. 1A-B. Although the common features between table saw 110 and table saw 10 will be identified via reference numeral in such manner, these items will not be discussed in detail in order to avoid redundant descriptions.

In this embodiment, both extension portions 126 and 128 are movable between first positions wherein the extension portions are extended into work supporting positions (FIGS. 2C-D) and a second position wherein the extension portions are moved into a stored position (FIGS. 2A-B). When extended into the work supporting positions, as illustrated in FIGS. 2C-D, the extensions 126 and 128 are supported by braces such as retractable handles 130a-b. The handles 130a-b and extensions can be secured into position in a manner similar to that discussed above with respect to FIGS. 1A-B. By allowing the extensions 126 and 128 to be retracted, the apparatus 110 becomes more compact and easier to move from work site to work site. This configuration also allows the apparatus 110 to be adjusted in a variety of ways to accommodate the specific work site and spatial limitations thereof.

In a preferred form, the extensions 126 and 128 further define openings or cutouts 134a-b, which form recesses that allow an operator to more easily grasp handles 130a-b when the extensions 126 and 128 are in the stored position. Unlike the cutout 34 of FIGS. 1A-B, however, cutouts 134a-b are designed so that a portion of the upper surface of the extension remains. Thus, when the extensions 126 and 128 are in their work supporting position they form a uniformly flat surface with the upper surface of table 112. This configuration avoids leaving any openings in the upper surface of extension portions 126 and 128, or between the extensions 126 and 128 and the table 112, to ensure that workpieces do not catch when trying to feed the workpiece into the blade 116.

In the embodiment illustrated in FIGS. 2A-D, the table saw 110 includes a support member 138 which is similar to bar support 38 discussed above. More particularly, bar support 138 includes a retractable bar connected to the table saw 110 via posts 138a-b. The bar support 138 can be moved between an extended position and a retracted position and preferably includes rollers 140 which allow workpieces to be moved over the support 138 more easily. Unlike support 38, however, the posts 138a-b of bar support 138 are spaced closer together so that the support 138 can be removed from the rear of the table saw 110 and repositioned off of one of the side extension portions 126 or 128, as illustrated in FIG. 2D. Thus, in instances where the workpiece requires support off to the side of the table saw, rather than behind, the bar support 138 can be repositioned from the rear of the apparatus 110 to the side to support the overhanging portion of the workpiece. In alternate embodiments, apparatus 110 may be provided with a combination of supports 138 extending from the rear and sides of the apparatus 110.

In a preferred form, the extension portions 126 and 128 have openings 180 (FIG. 2D) into which posts 138a-b may be inserted to extend the support 138 therefrom. As with support 38 and table 12, support 138 may be connected to table 112 or extensions 126 and 128 in a variety of fashions, such as a frictional engagement, fasteners, mating structures, or the like. In the embodiment illustrated, the support 138 is prevented from accidental removal from the table saw 112 and extensions 126 and 128 via stops, such as set screws, located at the distal end of posts 138a-b. Thus, in order to remove the support 138 from the table saw 112 or extensions 126 and 128, the set screws must be removed from the distal ends of the posts 138a-b or screwed into the posts 138a-b a sufficient amount so that the posts 138a-b and screws can clear the openings into which the posts are inserted. In alternate embodiments, other forms of stops, such as clips, projections, or the like, may be used.

Table saw 110 includes a pair of rails 144a-b, which run the length of the table 12. As with apparatus 10, a fence is attached to the railings and used to align a workpiece for cutting operations. In a preferred form, the rail 144a has a recessed portion upon which indicia such as rulings may be placed and the fence has an indicator for displaying the rulings on the rail so that measured movement of the fence may be made in an accurate and efficient manner. As will be discussed in further detail below, the fence is attached to the railings 144a-b and fixed in a desired position on the railing by moving the fence handle from an unlock position to a lock position wherein the fence is clamped securely in place on the rails 144a-b.

In the embodiment illustrated in FIGS. 2A-D, panel 154 of base 114 defines a single opening 170 through which a blade height adjustment shaft extends. As discussed above, indicia, such as rulings, may be located on a surface adjacent opening 170 so that both the blade height adjustment shaft and the blade angle adjustment indicator may extend from the same opening, rather than requiring an additional opening such as opening 72 in FIGS. 1A-D. Thus, when the blade angle is adjusted, both the blade height adjustment shaft and the blade angle indicator will move along the arcuate path of opening 170. For example, indicia may be placed on a protruding portion 182 of panel 154 in FIGS. 2A-D, so that the apparatus 110 can clearly display the blade angle. In a preferred form, the protruding portion 182 has an outer surface which is angled with respect to panel 154 so that the operator can more easily see and read the indicia located thereon. However, in the embodiment illustrated in FIGS. 2A-D, no indicia is needed because the blade angle is indicated on a display, such as digital display 184 (FIG. 2B).

In one form, the display 184 may be a Liquid Crystal Display (LCD) which is connected to an electronic circuit having a controller capable of determining the blade angle or height and a LCD driver for displaying the determined blade angle or height on display 184. For example, the apparatus 110 may use a conventional absolute positioning encoder circuit to determine the position of the blade angle or height and output signals corresponding to the position to an LCD driver, which in turn displays the blade angle or height on the LCD. Such encoders are often used to keep track of the position of movable articles. For example, the apparatus 110 may use any of a number of encoders provided by manufacturers, such as Gurley Precision Instruments of Troy, N.Y., which allow it to track the absolute position of the blade angle or height and display the same on display 184. One such circuit is disclosed in U.S. Pat. No. 5,642,297 issued Jun. 24, 1997, which is hereby incorporated herein by reference in its entirety.

In FIG. 2B, the display 184 has inputs 184a-b which maybe used for calibrating the display to the appropriate blade angle or height and/or electronically adjusting the blade angle or height in place of the traditional means which typically involve rotating the blade angle adjustment shaft or blade height shaft via a spindle or hand wheel. In the embodiment illustrated, the display 184 is angled with respect to panel 154 in order to tilt the display so that it may be more easily seen by the operator and read from above the body 114.

Base 114 may also include an integrated accessory holder, such as fence storage bracket 186, where the fence may be placed when not in use. The bracket 186 may be molded integrally to the base 114 or may be a separate structure attached to base 114 via a fastener, such as a screw or bolt. In the embodiment illustrated, the brackets 186 are U-shaped and are formed integrally with the base 114. The fence may connect to the bracket 186 in a variety of ways, including frictional engagement, fasteners such as clips, buttons or straps, mating structures, or the like.

As illustrated in FIGS. 2A-D, the apparatus 110 further includes a power control, such as actuator 188. The actuator 188 has an outer casing 188a within which a toggle switch 188b is mounted. The actuator 188 is designed such that power may not be applied inadvertently by bumping into the saw 110. More particularly, the toggle switch 188b must be pulled out from the casing 188a in order to actuate the blade. To assist the operator in pulling the switch 188b out from the casing 188a, notches are made in the casing 188a so that an operator can grasp at least a portion of the side of the switch 188b in order to pull it out from the casing 188a. The saw will continue to operate until the switch 188b is pressed back into the casing 188a. Thus, if an operator inadvertently bumps the switch 188, the switch 188 will remain in, or return to, the off position rather than unexpectedly starting the blade 118.

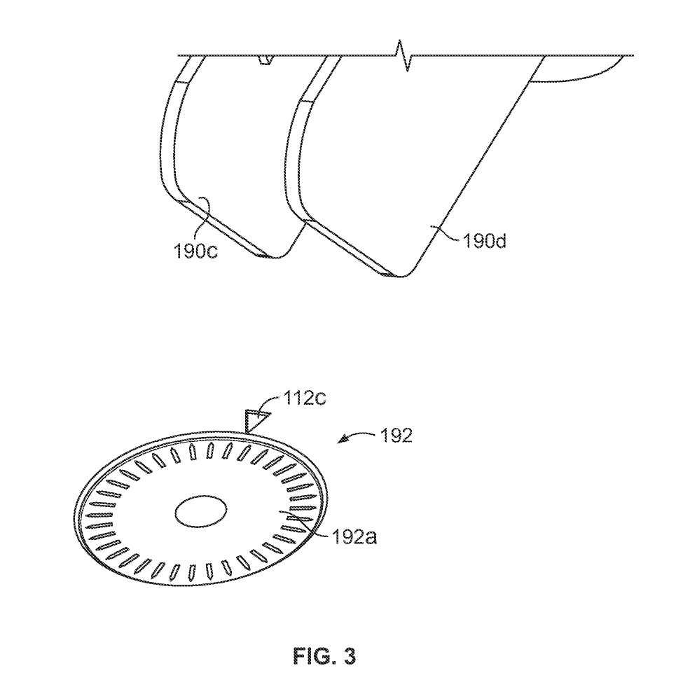

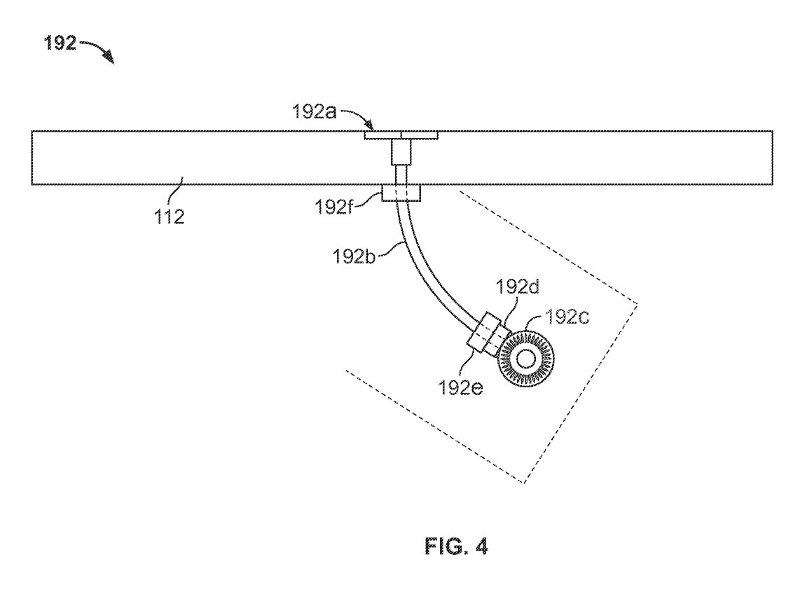

A traditional splitter and guard assembly 190 may also be connected to the table saw 110. The splitter and guard assembly include a standard splitter 190a, splitter bar 190b, blade guards 190c-d, and anti-kickback pawls. The apparatus 110 illustrated in FIGS. 2A-D, includes a second blade height indicator, such as incremental height gauge 192, which allows the operator to make measured height adjustments quickly and accurately. As best illustrated in FIGS. 3 and 4, the height gauge 192 is fed through an opening in table 112 and includes a display, such as gauge 192a, connected to a shaft 192b which is driven by the blade height adjustment shaft extending through opening 170. The display 192a includes incremental markings which correspond to a measured distance of travel by the blade 118 when the blade height adjustment lever is rotated. Thus, an operator can make fine adjustments, such as micro adjustments, to the blade height in various increments by simply rotating the spindle connected to the blade height adjustment shaft and watching the display 192b located on the surface of table 112. Such a configuration is particularly advantageous when performing blind cuts, such as dado cuts, on a workpiece due to the operators need to accurately maintain the position of the workpiece and adjust the blade height.

In a preferred embodiment, the shaft 192b is a flex shaft which is connected to the blade height adjustment shaft via a pair of mating bevel gears 192c-d. To assist the shaft 192b in rotating in conjunction with the blade height adjustment shaft, bearing mounts 192e-f are positioned at opposite ends of the flex shaft 192b proximate to the bevel gear 192d and table 112. In one form, a quarter inch flex shaft is used for shaft 192b and the mating bevel gears 192c-d have a ratio allowing for the blade height to be adjusted one-sixteenth inch for every 360° rotation of disc 192a. Thus, one full rotation of disc 192c will result in the blade 118 being raised or lowered by one-sixteenth inch (depending on the direction of rotation of the spindle). The table 112 may include indicia, such as arrow 112c, for accurately tracking rotation of the display 192a.

It should be understood, however, that the bevel gears 192c-d and disc 192a may be designed to achieve any incremental adjustment of height desired, (e.g., one 360° rotation may raise or lower the blade one-eighth inch, one-thirty-second inch, etc.). It should also be understood, that the incremental markings on display 192a may alternately be placed on the table 112 and the disc 192a may form a shaft or needle rotating about the incremental markings. With this configuration, an operator can make fine adjustments to the blade height in various increments by simply rotating the spindle connected to the blade height adjustment shaft and watching the display needle rotate about the incremental markings on the table 112.

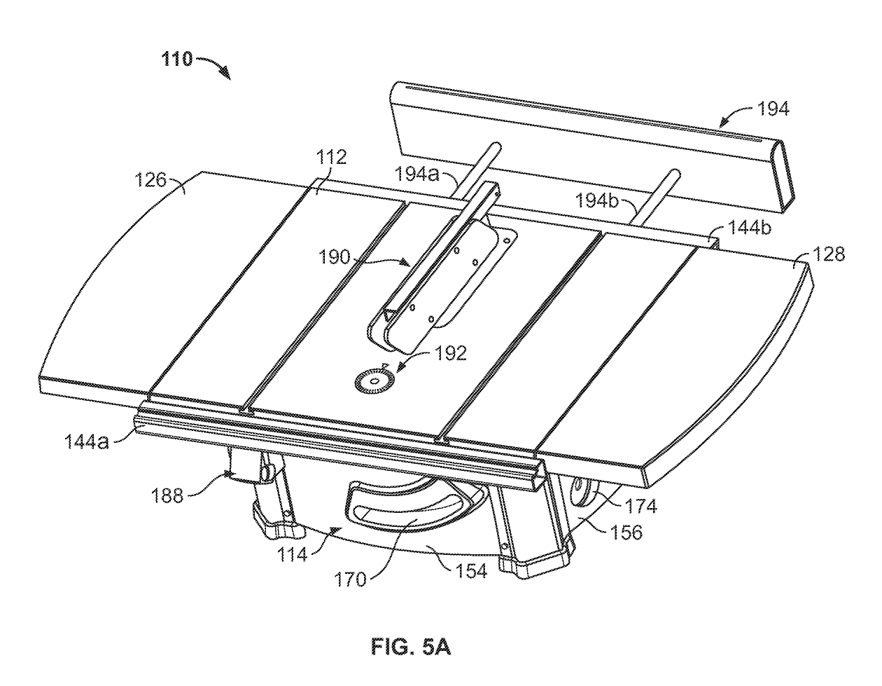

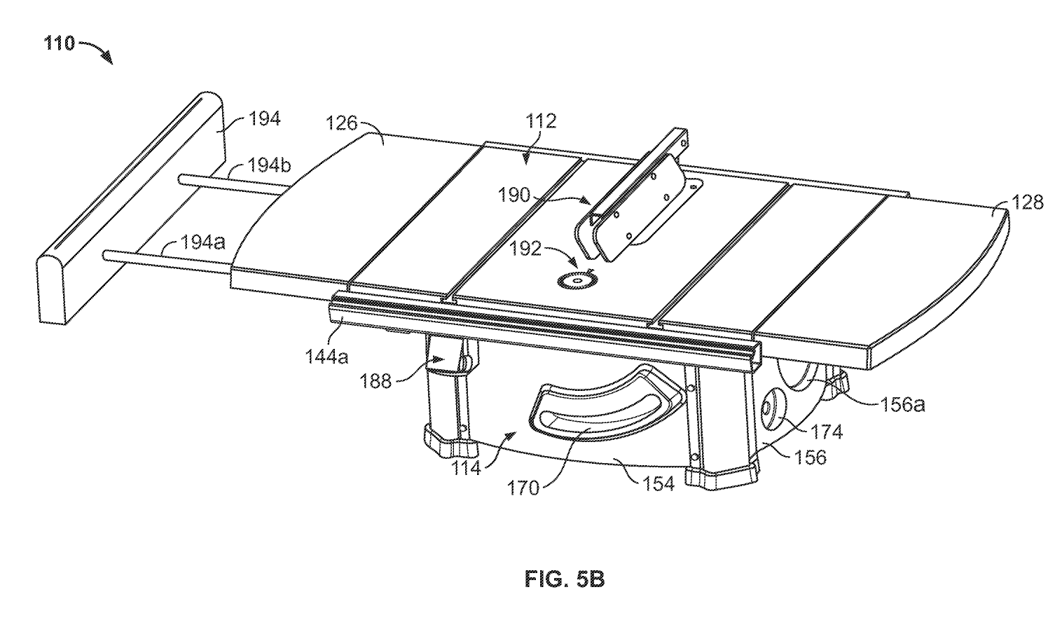

In FIGS. 5A-B, an alternate support 194 is illustrated. In this embodiment, the support comprises a retractable bar which extends from table 112 via posts 194a-b. As with support 138, support 194 can be spaced from the table 112 at a variety of distances. For example, support 194 may be positioned adjacent the table 112 or positioned several inches, if not feet, away from the table (as illustrated in FIG. 5A). The top of the support 194 is rounded so that the portions of workpiece overhanging the table 112 can easily be moved over the support 194 without binding or the like. As discussed above with respect to FIGS. 2A-D, the support 194 may be removed from the rear of the table saw 110 and repositioned off of one of the extensions 126 and 128, if desired. In an alternate embodiment, supports may be positioned off of both the rear and side of the table saw 110.

In the embodiment illustrated in FIGS. 5A-B, the apparatus 110 further includes a blade storage compartment or sleeve 156a within which extra cutting implements may be stored. More particularly, panel 156 defines a circular pocket 156a into which additional blades, such as new or replacement blades or dado blades, may be stored. The pocket 156a is located intermediate the ends of panel 156 in the thickened panel portion and is formed by covering a recess in panel 156 with a curved outer wall. This configuration allows for a deep pocket to be formed in panel 156 with a large opening so that blades can be inserted and removed from pocket 156 more easily. This and other body accessories will be discussed in further detail below.

Yet another embodiment of apparatus 10 and 110 is disclosed in FIGS. 6A-G and is referred to generally by reference numeral 210. As with FIGS. 2A-5B above, parts identified in FIGS. 6A-G which are similar to those previously discussed in FIGS. 1A-B and FIGS. 2A-5B are similarly numbered with the exception of having a prefix “2” in addition to the number used in FIGS. 1A-B or in place of the prefix “1” used in FIGS. 2A-5B. For example, table saw 210 of FIGS. 6A-G has a table 212 and base 214 which are similar to the table 12 and base 14 from FIGS. 1A-B and table 112 and 114 from FIGS. 6A-G.

In this embodiment, extension portion 226 is movable between a first position wherein the extension portion is extended into a work supporting position (FIG. 6B) and a second position wherein the extension portion is retracted into a stored position (FIGS. 6A and 6C-G). Alternatively, however, extension portion 228 is provided as a sliding extension portion which is movable between a first extended position, wherein the extension portion is extended to support larger workpieces (FIG. 6B) and a second compacted or retracted position, wherein the extension portion is retracted to support smaller workpieces (FIGS. 6A and 6C-G). More particularly, table saw 210 has a pair of elongated rails 244a-b which allow extension portion 228 to be moved between the first and second positions as desired. In a preferred form, extension portion 228 is connected to rails 244a-b in a tongue and groove fashion and may be placed in varying positions between rails 244a-b in order to account for various sizes of workpieces. In an alternate embodiment, extension portion 228 is connected to rails 244a-b via fasteners, such as bolts, which pass through channels in rails 244a-b and form a frictional engagement therewith such that the extension portion 228 can be moved back and forth along the rails 244a-b, but will remain in the position it is placed on the rails 244a-b.

In the embodiment illustrated in FIGS. 6A-G, the upper surface of extension portion 228 remains level with the upper surface of table 212 as the extension portion is slid along rails 244a-b. Thus, when the extension 228 is moved to the second position adjacent the table 212 (FIGS. 6A and 6C-G), a flat upper surface is created between table 212 and extension 228. In a preferred embodiment, table 212 and extension 228 are designed with mating members to align the extension 228 with the table 212 so that a generally seamless flat surface is created thereby. For example, in FIGS. 6A-G, extension 228 includes a pair of dowel pins (not shown) which are located on the side surface facing table 212. When positioned in the retracted position, the dowel pins of extension 228 are inserted into alignment openings 212d-e (FIG. 6B) which are located on the side surface of table 212 facing extension 228. It should be understood, however, that the dowel pins may extend from table 212 and the alignment openings may be located on extension 228, if desired. It should also be understood, that either extension portion 226 or 228, or both, may be provided as slidable extension portions. In another form, the extension 228 and table 212 may be designed with a lock or fastener to keep the extension portion and table connected to one another when the extension portion is in the second position. This configuration allows the apparatus to be secured so that it may be more easily moved from site-to-site.

FIGS. 6E-G illustrate the assembly of base 214, including interchangeable leg posts 246-252 and feet 262-268, and panels 254-260. In a preferred form, the panels 254-260 are connected to posts 246-252 using socket head cap screw and nut fasteners, and the feet 262-268 are frictionally fit over the lower portion of posts 246-252. The modular construction of base 214 allows for the apparatus 210 to be provided in a variety of models with a variety of features. For example, as illustrated in FIGS. 7A-D, the apparatus 210 may be provided with a number of different panels 254-260 and each panel may provide a number of different accessories such as the blade storage pocket 256a discussed above.

In FIGS. 7A-B, base 214 is illustrated with a front panel 254 having a raised portion 282 which defines blade height adjustment opening 270. A right panel 256 having a blade storage pocket 256a and an opening 274 (FIG. 6G) for the blade angle adjustment shaft. A rear panel 258 defining a dust collection port or opening 258a for receiving the hose of a dust collection system, and a rear splitter support opening 258b for receiving portions of a standard rear splitter assembly. A left panel 260 having a fence support 260a for storing fence 242 when not in use, and a miter gauge support 260b for storing miter gauge 296 when not in use. In a preferred embodiment, these accessories are formed integral to the molded plastic base 214. However, in alternate embodiments accessories, such as fence support 260a, may be separate components attached to the base 214 via fasteners.

Alternate accessories for panels 254-260 are illustrated in FIGS. 7C-D. More particularly, panels 254-260 may include a power cord storage accessory, such as cord wrap 258c (FIG. 7C), or storage compartments, such as tray 256b (FIG. 7D), for carrying accessories such as the apparatus owner's manual or tools such as wrenches for removing and installing blades on the apparatus. Thus, the modular configuration of base 214 allows the apparatus 210 to be provided in a variety of different models and/or with a variety of different features quickly and easily. For example, a standard model of apparatus 214 may be provided with no base accessories, a mid-level model may be provided with some base accessories, such as fence storage 260a and miter storage 260b, and a high-end model may be provided with several features, such as fence storage 260a, miter gauge storage 260b, cord wrap 258c, blade storage 256a, wrench and owners manual storage 256b. Alternatively, the modular configuration of base 214 allows the apparatus to be customized to the operators desire. The modular design of base 214 also makes it easier to provide replacement panels and/or upgradable panels so that operators may continue using and upgrading the apparatus 210.

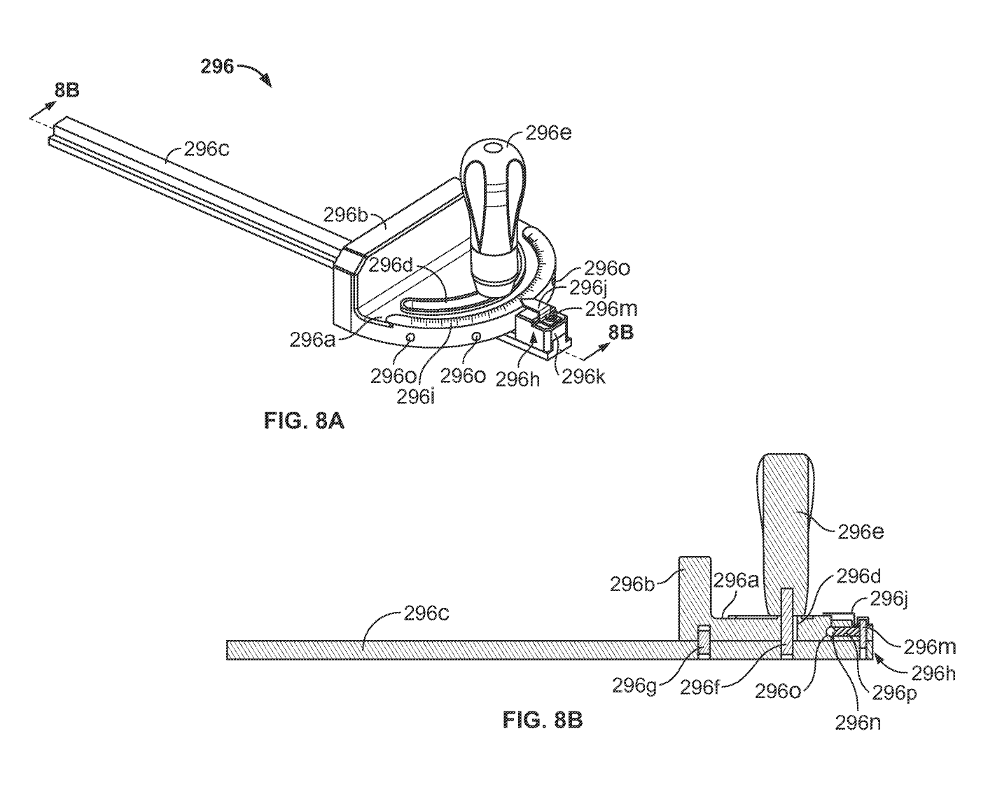

The miter gauge 296 of FIG. 7B may be used to align and feed workpieces into the blade 216 so that the desired cut may be made thereto. For example, miter gauge 296 may be slid into one of the guides 212a-b located in the surface of table 212 and used to align a workpiece into a desired angle for cutting and then feed the workpiece into the blade at the desired angle. In essence, the miter gauge 296 operates like a protractor mounted on a pivot axis. As illustrated in FIGS. 8A-B, miter gauge 296 includes a base 296a with an upstanding wall 296b extending therefrom and a guide, such as T-bar 296c. The base 296a is semicircular in shape with wall 296b extending from the flat end thereof. The semicircular portion of the base defines an arcuate channel 296d and is connected to the guide bar 296c via handle 296e. More particularly, handle 296e has a threaded shaft 296f extending therefrom which passes through channel 296d and screws into a threaded bore located in the upper surface of guide 296c. The base 296a and wall 296b are also interconnected to guide 296c via a pivot post 296g. Thus, when handle 296e has been unscrewed a sufficient amount, the arcuate channel 296d allows the base 296a and wall 296b to be pivoted about post 296g and positioned at a variety of angles with respect to guide 296c. Once the desired angle has been reached, the handle 296e may be screwed into engagement with the base 296a to lock the base in the desired position.

An indicator 296h is fixed to guide 296d and points to indicia, such as rulings 296i, to identify the angle of wall 296b with respect to guide 296c. In one form, the indicator 296h is fixed to an end of the guide 296c and includes a pointer, such as needle 296j, which is connected to body 296k via a fastener, such as screw 296m. As mentioned above, the angle of wall 296b is adjusted by unscrewing handle 296e a sufficient amount to allow the base 296a and wall 296b to be moved with respect to the guide 296c. Once the needle 296j points to the desired angle rulings 296i, indicating that wall 296b is positioned at the desired angle, the handle 296e is screwed into engagement with base 296a to secure the base 296a and wall 296b in place. Thus, in operation, T-bar 296c is inserted into the mating T-slot 212a or 212b, and the wall 296b is adjusted to the desired angle for aligning and feeding a workpiece into the blade.

In a preferred embodiment, the miter gauge 296 includes a passive angle setting assembly which automatically detects when a predetermined angle has been reached and releasably locks the base 296a and wall 296b at that angle. If an angle other than the predetermined angle is desired, the base 296a and wall 296b may continue to be rotated until the desired angle has been reached. Thus, the passive angle setting assembly requires no operator interaction with the angle locking feature in order to move from one angle to another or from one predetermined angle to another. In the embodiment illustrated in FIGS. 7B and 8A-B, the passive angle setting assembly includes a ball and detent assembly wherein a biased ball 296n moves in and out of detents 296o positioned at a variety of positions corresponding to predetermined angles of wall 296b with respect to guide 296c. More particularly, ball 296n moves between a first position wherein the ball 296n is located within a bore defined by the indicator body 296k thereby compressing spring 296p and a second position wherein the ball is extended into detents 296o located at predetermined positions about an outer side wall of base 296a to match selected angles. The spring 296p also is in the bore and biases the ball 296n in the second or detent engaging position, however, the operator may continue to rotate the base 296a and wall 296b such that the ball 296n is returned to the first position, if desired. In the embodiment illustrated, the selected angles at which the ball is placed in a detent are 90°, 30° and 45° so that the passive angle setting assembly automatically detects when the wall has been positioned at 90°, 30° and 45° with respect to guide 296c via the ball 296n moving into detents 296o. It should be understood, however, that the miter gauge 296 may be configured to automatically detect any number of different predetermined angles as desired.

In an alternate embodiment, the positions of the ball 296n and detents 296o may be interchanged such that the indicator body 296k includes a detent and the base 296a includes a plurality of biased balls located at a variety of positions corresponding to predetermined angles of wall 296b with respect to guide 296c. For example, in the embodiment illustrated in FIG. 8A, detents 296o could be replaced with biased balls, and the biased ball 296n could be replaced with a detent for receiving any of the plurality of biased balls.

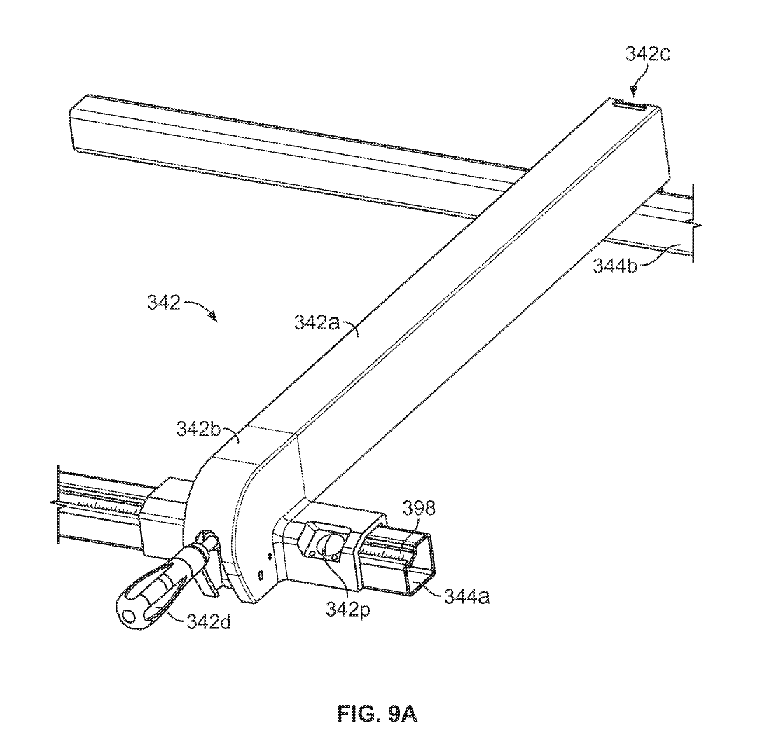

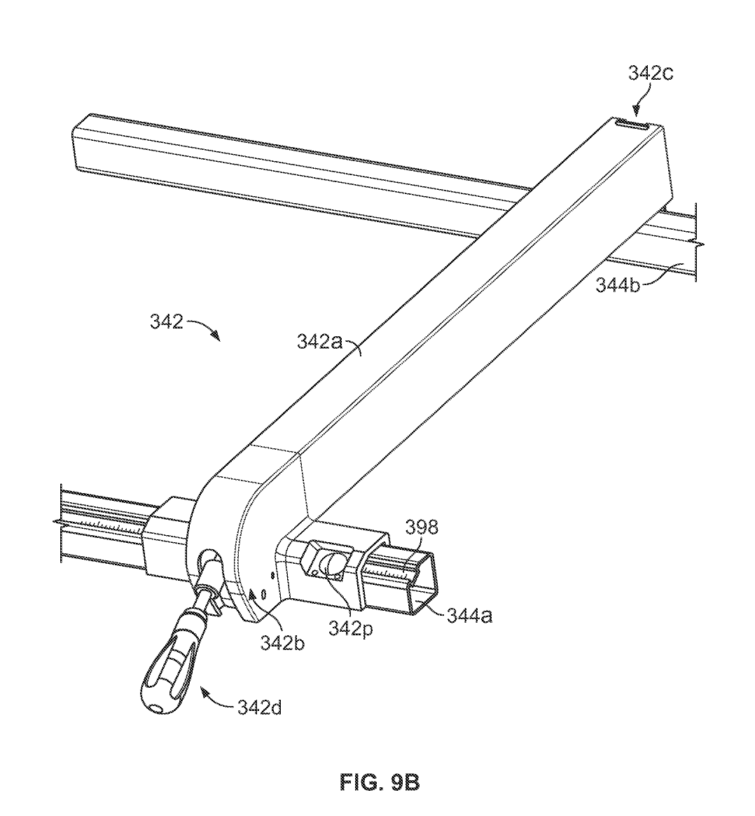

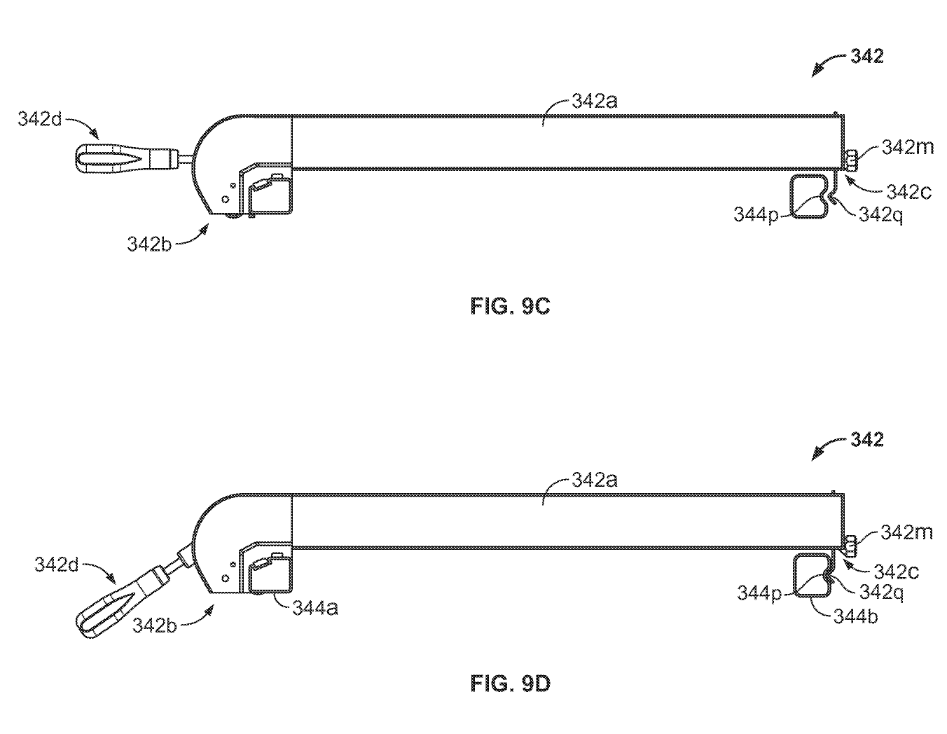

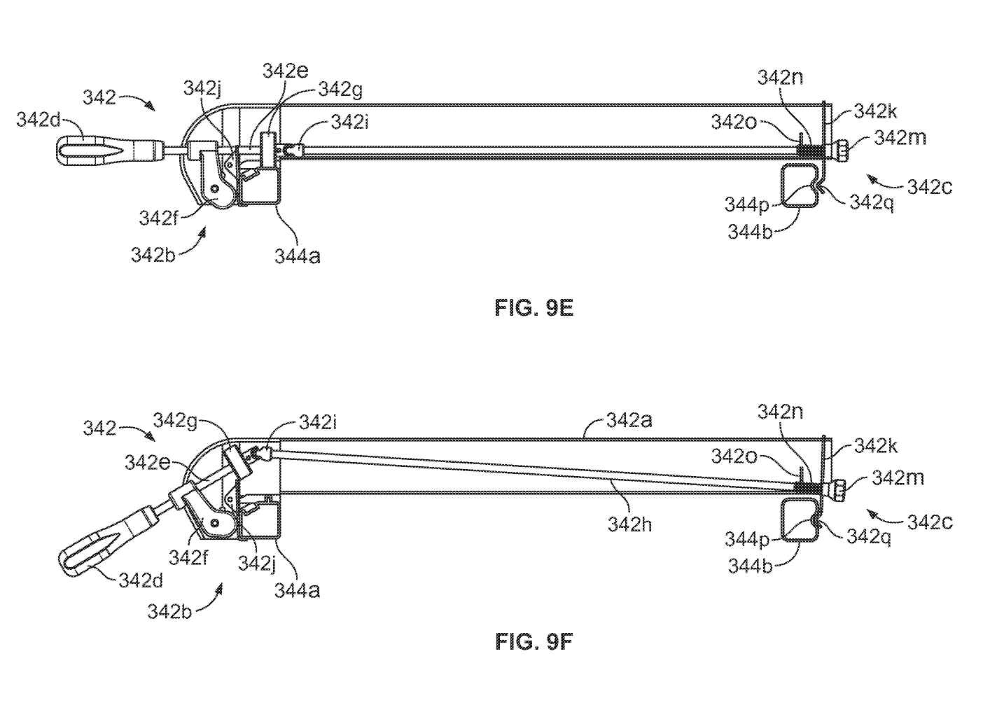

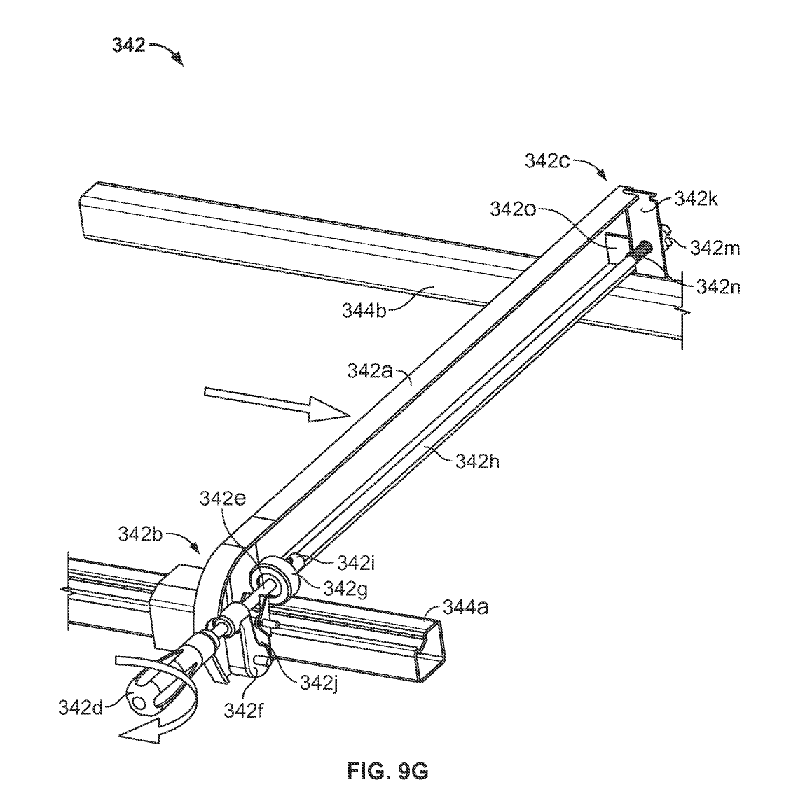

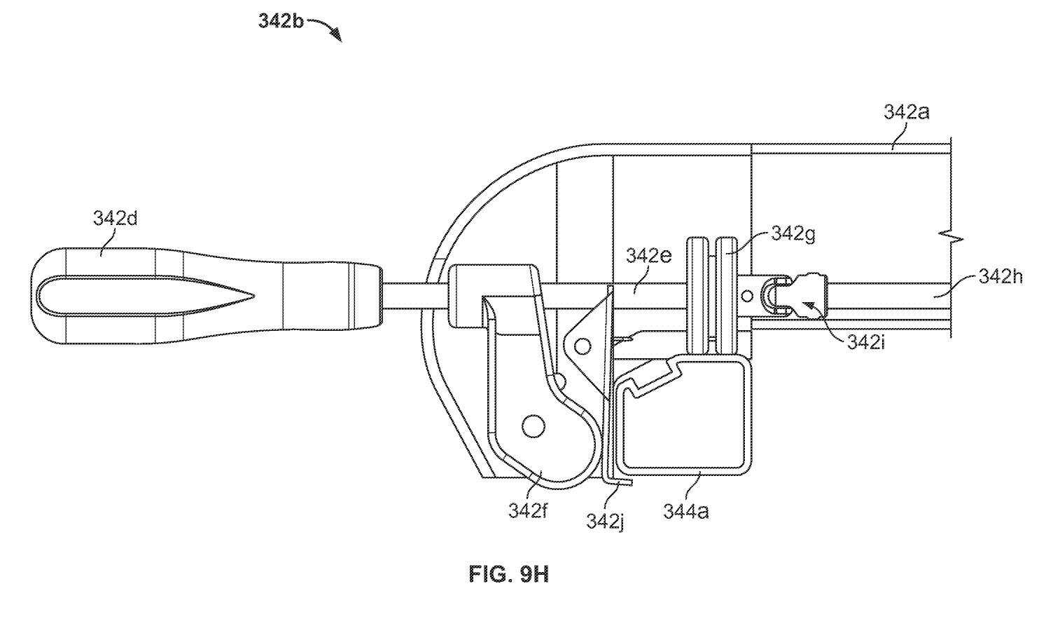

FIGS. 9A-I illustrate an alternate fence which may be used in place of fence 42 (FIGS. 1A-B) and fence 242 (FIG. 7B), and in conjunction with the power tools discussed herein. The fence illustrated in FIGS. 9A-I will be referred to generally by reference numeral 342 and includes an elongated body 342a extending between first and second end members 342b-c, respectively, and an actuator, such as handle 342d. In operation, the fence 342 is placed on rails 344a-b of the table saw, moved to the desired position on the rails for aligning a workpiece to be cut by the cutting implement, and secured into position by operation of the handle 342d. Movement of the fence 342 along rails 344a-b typically involves making coarse adjustments by sliding the fence by hand and making fine adjustments via a separate positioning handle. In the embodiment illustrated in FIGS. 9A-I, however, handle 342d may be used for both fine adjusting of the fence 342 along the rails 344a-b and securing the fence 342 in the desired position along the rails. Thus, there is no need for separate positioning and lock down handles.

In a preferred form of fence 342, handle 342d has a shaft 342e which extends from the handle 342d, through a locking member, such as cam 342f, and a positioning member, such as wheel 342g, and is connected to an elongated shaft 342h which runs the length of body 342a. More particularly, the distal end of handle shaft 342e is connected to elongated shaft 342h via a universal joint, such as ball joint 342i. The handle 342d is movable between a first position wherein the cam 342f is placed in a fence releasing position and the positioning wheel 342g engages rail 344a (FIGS. 9A, 9C, 9E and 9H), and a second position wherein the cam 342f engages and/or drives a pivoting clamp member 342j into a fence securing position and the positioning wheel 342g is removed from rail 344a (FIGS. 9B, 9D, 9F and 9I).

In one form, the handle shaft 342e and elongated shaft 342h are made from steel, and the cam 342f is made from powdered metal. The positioning wheel 342g has an outer rubber surface which frictionally engages an outer surface of rail 344a when the handle 342d is in the fence releasing position. In alternate embodiments, however, the positioning member 342g may consist of structures other than a wheel having an outer rubber surface. For example, in one form, the positioning member 342g may include a pinion gear having a plurality of teeth which is designed to engage mating teeth located on a surface of rail 344a in a rack-and-pinion type configuration. In an alternate embodiment, as illustrated in FIGS. 9H-I, the positioning member 342g may comprise of a dual wheel member having a guide, such as upstanding wall member 344c located on rail 342a for ensuring linear movement of the fence 342 along rails 344a-b so that the fence remains square to the rails. In yet another embodiment, a separate positioning member may be provided for each rail 344a-b. For example, rail 344a may be frictionally engaged by one wheel member when the handle 342d is in the fence release position, and rail 344b may be frictionally engaged by a second wheel member.

The opposite end of the elongated shaft 342h is connected to the second end member 344c of fence 342. In the form illustrated, the opposite end of the elongated shaft 342h is threaded and is connected to a pivoting end member 342k by a fastener, such as a nut 342m. A spring 342n is disposed between the pivoting end member 342k and an end stop, such as spring block 342o, which is either connected to the fence 342 or the elongated shaft 342h. The spring 342n biases the pivoting end member 342k away from the rail 344b and against the fastener 342m. This facilitates movement of the fence along the rail when the handle 342d is in the unlocked position. Thus, the spring 342n pushes the pivoting end member 342k and is capable of pivoting end member 342k away from the rail when the handle 342d is in the first position (or fence release position).

The free end of the pivoting end member 342k is formed with a wedge 342q that fits into a complementary shaped groove 344p along the rail 344b. More particularly, the wedge 342q fits with the groove 344p when the handle is shifted to the fence lock position. This engagement prohibits the second end 342c of the fence from inadvertent movement when the handle 342d is in the locked position.

FIGS. 9A, 9C, 9E and 9H show the fence 342 positioned about rails 344a-b with the handle 342d in the fence release position. When the handle 342d is in this position, the fence may be manually slid back and forth along the rails in order to make large scale or coarse adjustments. Alternatively, the handle 342d may be rotated in a clockwise or counterclockwise fashion in order to make smaller scale or fine adjustments (e.g., micro adjustments or movements). More particularly, rotation of the handle 342d causes a similar rotation of the wheel 342g, which frictionally engages the upper surface of rail 344a and causes the fence 342 to move with respect thereto. In the form illustrated, clockwise rotation of handle 342d walks the fence 342 to the right along the rails 344a-b (as illustrated in FIG. 9G), and counterclockwise rotation of the handle 342d walks the fence 342 to the left along the rails 344a-b.

FIGS. 9B, 9D, 9F and 9I show the fence 342 positioned about the rails 344a-b with the handle 342d in the fence securing position. When the handle 342d is in this position, the fence is clamped into a fixed position on the rails 344a-b so that it can align a workpiece without inadvertent movement taking place. Thus, when the handle is moved from the first position to the second position, the cam 342f shifts pivoting clamp member 342j into engagement with rail 344a to prevent the fence 342 from moving with respect to rails 344a-b and positioning wheel 342g is moved out of engagement with the rail 344a. Also, the shaft 342h pivots the pivoting end member 342k so the wedge 342q moves into the groove 344p to secure this opposite end of the fence against inadvertent movement.

As mentioned above, the rail 344a may have indicia, such as rulings 398 (FIGS. 9A-B), which the operator may use to make measured movements of the fence 342. The fence 342 may also include an indicator, such as optical reference guide 342p, for using in conjunction with indicia 398 to provide an operator a reference for the location of the fence 342 and/or allow the operator to make accurately measured movements of the fence 342. In the form illustrated, optical reference guide 342p comprises a transparent plexiglass window with a vertical reference line for aligning the fence 342 with the rulings 398 located on a surface of the rail 344a. The transparent window may also provide magnifying capabilities, (e.g., magnifying glass), to assist the operator in reading indicia 398.

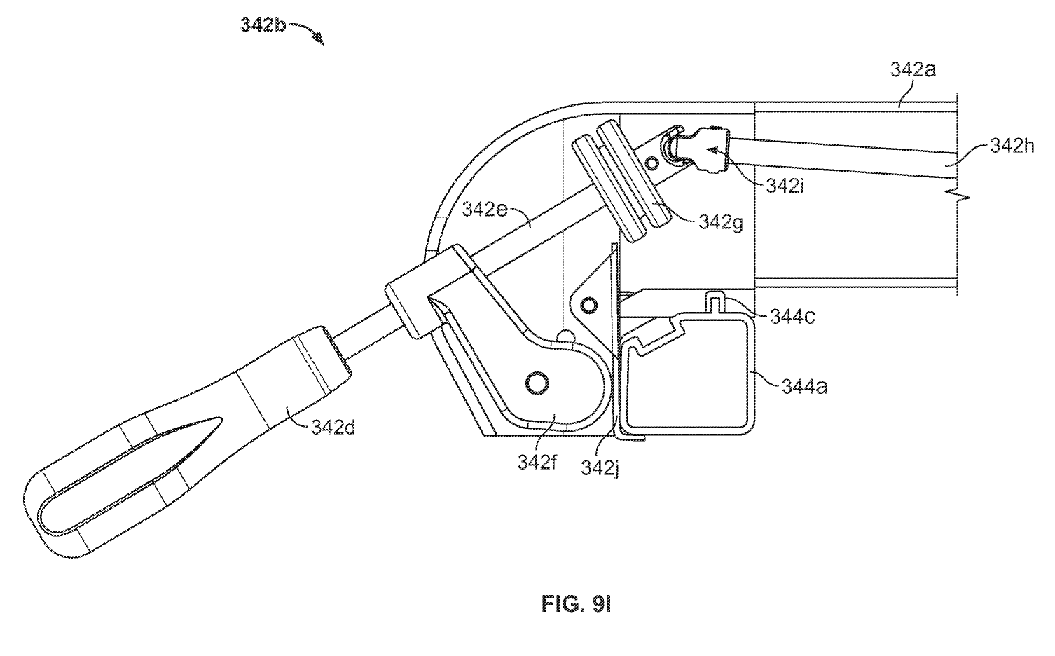

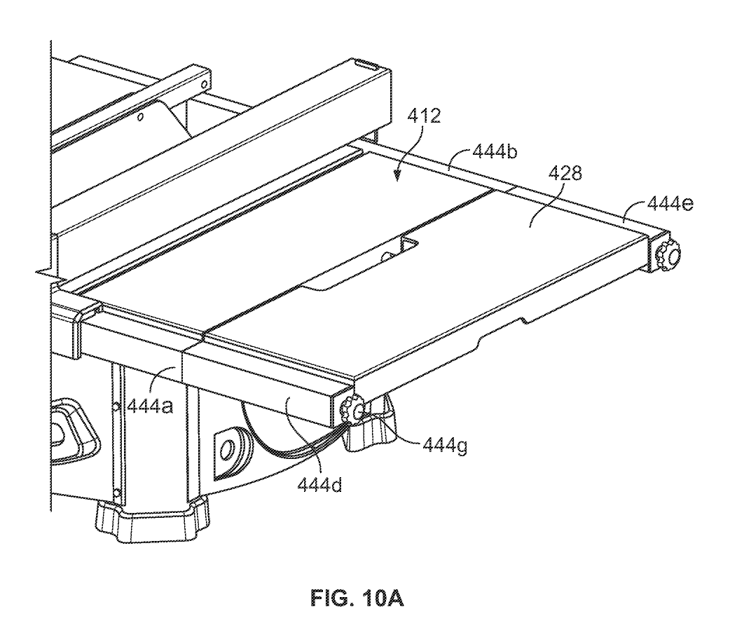

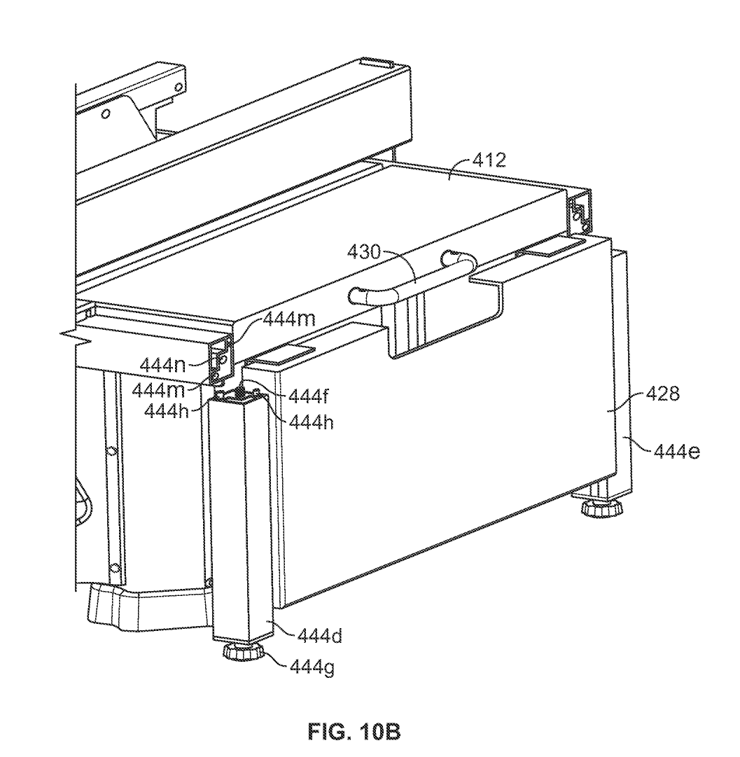

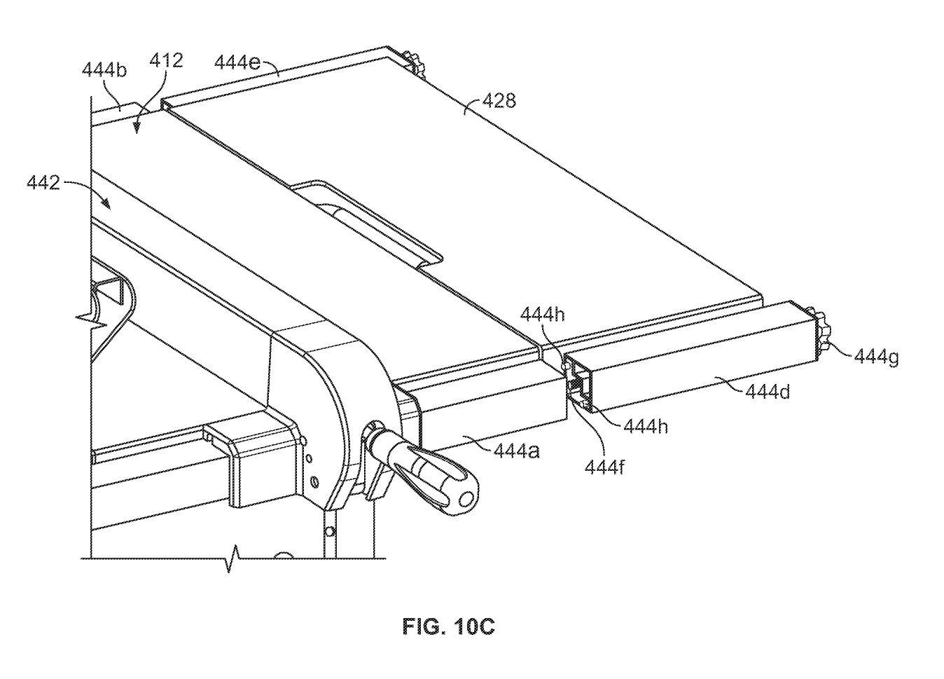

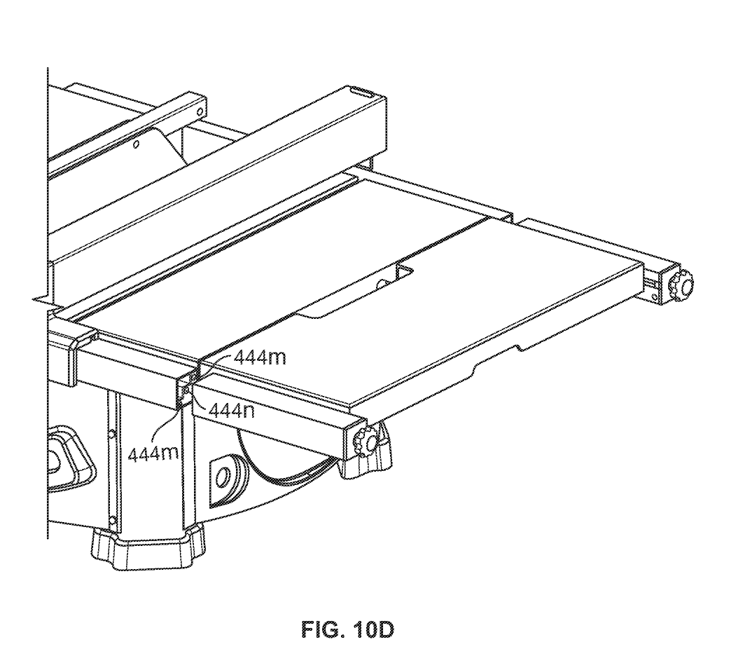

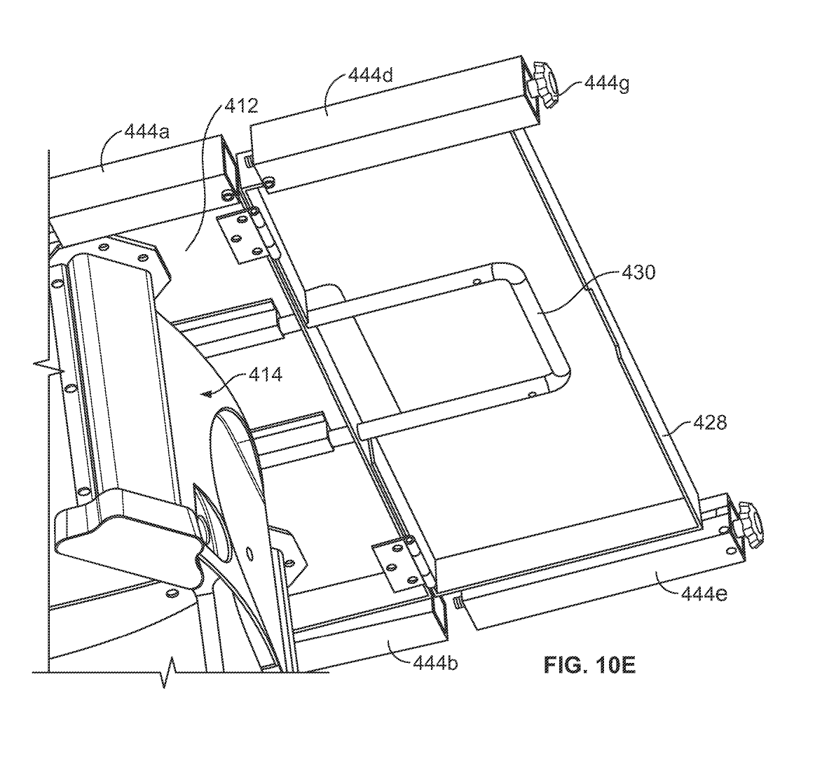

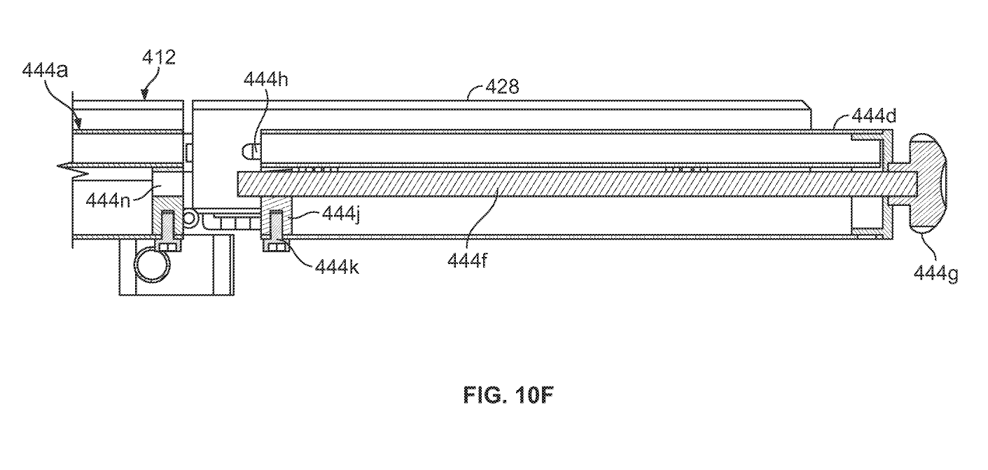

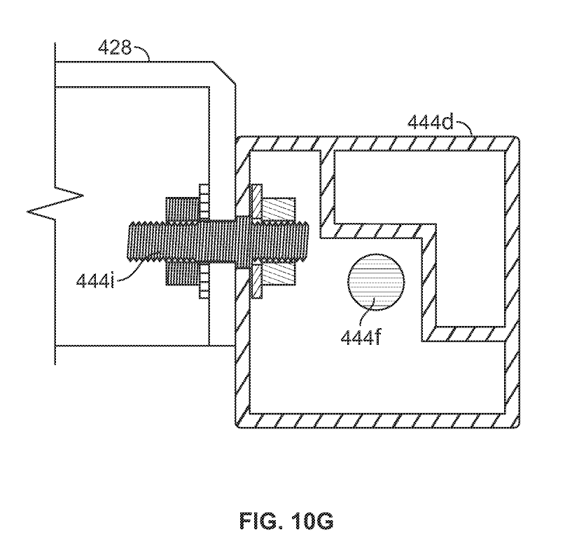

In an alternate embodiment, the rails may also be designed to move between a first position wherein the rails are extended for supporting the extension portions and/or fence discussed above, and a second position wherein the rails are retracted into a stored position so that the table saw may be made more compact for transporting from site to site. Such a configuration is illustrated in FIGS. 10A-E. As with the drawing figures discussed above, parts identified in FIGS. 10A-E which are similar to those previously discussed are similarly numbered with the exception of having a prefix “4” in addition to the number used in FIGS. 1A-B or in place of the prefixes used in FIGS. 2A-9I.

In the embodiment illustrated, rails 444a-b have respective folding portions 444d-e, which can be moved between the extended position (FIG. 10A) and the stored position (FIG. 10B). In this form, rail portions 444d-e are connected to ends of the extension 428 and are foldable downward therewith for ease of transport from site to site. The rail portions 444d-e are slidable with respect to the extension 428 to assist the operator in connecting and disconnecting the rail portions 444d-e from their respective rails 444a-b. More particularly, the rail portions 444d-e are mounted to the table extension 428 via shoulder bolts 444i (FIG. 10G) with enough space between the bolt 444i, rail portion 444d and table extension 428 so that the rail portion 444d may be moved longitudinally with respect to the extension 428. In alternate embodiments, other types of engagements may be used to slidably connect the rail portions 444d-e to the extension 428, such as mortise and tenon, tongue and groove, wheel and track, or rail and sleeve type engagements.

Since the construction of rail portions 444d-e are mirror images of one another, only rail portion 444d will be discussed in detail below. More particularly, rail portion 444d includes an elongated shaft 444f which runs the length of the rail portion 444d and is connected on one end to a grip, such as handle 444g, and threaded on the other end for securing the rail portion 444d to rail 444a. In a preferred embodiment, the threaded shaft is fed through a fixed nut 444j (FIG. 10F) located in the rail portion 444d so that inadvertent removal of the elongated shaft 444f will not occur when the rail portion 444d is placed in the stored position (FIG. 10B). In the embodiment illustrated, the fixed nut 444j is secured to the rail portion 444d via a fastener, such as a screw 444k. The rail portion 444d also includes rail alignment structures, such as dowels 444h, which are received in complementary bores 444m in rail 444a to align the rail portion 444d with the rail 444a when secured in the extended position. It should be understood, however, that other types of alignment structures, such as those discussed above, may be used to help align the rail portions 444d-e in place of dowels and bores.

In operation, the rail portions 444d-e and extension 428 are moved from the stored position to the extended position and retractable handle 430 is moved into the extended position to brace the extension 428. The rail portion 444d is then slid into engagement with rail 444a such that the dowels 444h align with their respective openings 444m in rail 444a and the threaded shaft 444f aligns with the corresponding threaded bore 444n (FIGS. 10D and 10F) located in rail 444a. The shaft 444f is screwed into the threaded bore via handle 444g, thereby causing the rail portion 444e to be mounted flush to, and level with, the rail 444a. This configuration allows the fence 442 to slide along the rails without catching on anything, such as the seem between rails 444a-b and rail portions 444d-e. As mentioned above, the rear rail portion 444e and rear rail 444b may be connected in a similar manner.

Although the rail portions 444d-e are connected to the table extension 428 in the embodiment illustrated herein, it should be understood that the rail portions 444d-e do not have to be connected to the extensions 426-428 but, rather, could be freestanding such as the railing portions depicted in FIG. 6A. For example, in one form the foldable railings may be extended up into their work supporting position and a sliding table extension maybe moved out between the railing extensions to support a workpiece and allow a fence to be used in conjunction with the rail portions 444d-e to position the workpiece. The rail portion 444d may alternatively be connected to rail 444a by an arcuate bracket which defines the range of motion of the rail portions 444d such that the rail portion 444d is movable about an arcuate channel defined by the bracket so that it may be moved between extended and stored positions. In such an embodiment, the rail portion 444d may be secured to the rail 444a in the extended position in a manner similar to that discussed above.

Yet another embodiment of a power tool embodying features of the present invention is illustrated in FIGS. 11A-E and is referred to generally by reference numeral 510. In this embodiment, the power tool 510 includes leg extensions 598, 560, 602 and 604 (collectively “598-604”) which mate with the existing leg posts of the power tool 510 to convert the power tool from a bench top tool to a free standing tool, such as a contractor saw. For convenience, parts identified in FIGS. 11A-E which are similar to those previously discussed are similarly numbered with the exception of having a prefix “5” in addition to the number used in FIGS. 1A-B or in place of the prefixes used in FIGS. 2A-10G.

Like the saws discussed above, power tool 510 includes a table 512, a base 514 and corner posts 546, 548, 550 and 552 (collectively “546-552”) having rubber feet 562-568 connected thereto. However, power tool 510 has been converted from a bench top table saw like the saws discussed above, to a free standing table saw or contractor saw by attaching leg extension 598-604 to the corner posts 546-552. Since the corner posts 546-552 are identical to one another and interchangeable, and the leg extensions 598-604 are identical to one another and interchangeable, the following will describe the attachment of one leg extension (600) to one corner post (548) with the understanding that the remaining leg extensions 698 and 602-604 and corner posts 546 and 550-552 are connected in a similar manner. Furthermore, similar numbering will be used for each corner post 546-552 and each leg extension 598-604 so that the assembly of each leg extension may be understood through the following description.

Corner post 548 is used to connect side panel 554 and 556 to one another and to connect the side panels 554-556 to table 512. In the embodiment illustrated, the side panels 554-556 are fastened to the sides of the corner post 548 via fasteners such as screws or nuts and bolts. The upper and lower ends of the corner post, 548a and 548b respectively, are identical to one another and have projections extending therefrom which allow the corner post 548 to be connected to the table 512 and/or the extension 600. More particularly, each end of the corner post 548 has an outwardly extending flange 548c and a pair of inwardly extending flanges 548d which define holes through which bolts may be inserted to fasten the corner post 548 to the table 512 and/or the extension 600. For example, the openings defined by flanges 548c and 548d of the upper end 548a of corner post 548 are aligned with bolts extending downward from the bottom of the table 512 so that the post 548 may be connected to the table 512 by inserting the bolts through the holes of flanges 548c-d and fastening the flanges to the table 512 using washers and bolts. The flanges 458c-d of the bottom end 548b of corner post 548 are used to either connect the rubber foot 564 to the post 548 (when in the bench top configuration) or to leg extension 600 to the post 548 (when in the free standing configuration).

In the embodiment illustrated, the leg extension 600 has an outwardly extending flange 600c extending from the upper end thereof, and inwardly extending flanges 600d extending from a position between the ends of the leg extension 600. The flanges 600c-d define holes into which bolts are inserted to connect the leg extension 600 to the table 512 and the corner post 548. More particularly, the bolt used to connect the table 512 to flange 548c of the corner post 548 is also used to connect the table 512 to flange 600c of the leg extension 600. In a preferred form, the bolt is long enough do this without requiring the removal of the nut and washer holding the corner post 548 to the table 512. For example, the bolt connecting flange 548c of the corner post 548 to the table 512 may be aligned and inserted into the hole defined by the upper flange 600c of the leg extension 600. The leg extension may then be fastened to the bolt and table 512 by sandwiching the flange 600c between the nut securing the corner post flange 548c to the table 512 and a new washer and nut that is thread on over the bolt. It should be understood, however, that in alternate embodiments, the nut securing the corner post flange 548c to the table 512 may be removed and replaced after the bolt has been aligned and inserted into the hole defined by flange 600c if desired. An advantage to the former configuration, however, is that the power tool may be converted from its bench top configuration to its free standing configuration and vice versa more easily.

Before the leg extension 600 can be fully connected to the corner post 548, however, the rubber foot 564 must be removed from the end of the corner post 548. In the embodiment illustrated, the rubber foot 564 simply snaps onto or is friction fit onto the end 548b of the corner post 548. Thus, the rubber foot 564 may be removed by simply pulling the foot member 564 off of the end 548b thereby exposing the flanges 548c-d of the lower end 548b of corner post 548. Once the flanges 548c-d are exposed, the inwardly extending flanges 600d of the leg extension 600 may be aligned with the inwardly extending flanges 548d of the corner post 548 so that a fastener may be inserted into the holes defined by the flanges 548d and 600d to fasten the leg extension 600 to the bottom of the corner post 548 as illustrated in FIG. 11E.

The rubber foot 564 may be attached to the bottom end of the leg extension 600 by simply pressing the foot onto the end thereof. The foot 564 may be designed to snap onto or frictionally engage the bottom end of the leg extension 600 as desired. Thus, when the operator wishes to convert the apparatus 510 from its free standing configuration to its bench top configuration, he or she need only remove the rubber foot from the bottom end of the leg extension 600, remove the leg extension from the table 512 and corner post 548, and replace the foot 564 back onto the bottom end 548b of the corner post 548.

The leg extensions 598-604 may have any length that is sufficient to lift the base 514 and the table 512 a distance sufficiently above the ground, such that it may be used as a freestanding table saw and the table 512 is located at a height which is normal for table saws of that type. In addition, the shape of the leg extensions 598-604 will preferably correspond in shape to the shape of the corner posts 546-552, such that the leg extensions 598-604 may be easily mounted over the corner posts 546-552 when attached to the power tool 510.

While the illustrated leg extensions 598-604 are attached to the table saw 510 through the use of fasteners, the leg extensions 598-604 may alternatively be attached to the table saw 510 in any other way known in the art. For example, the leg extensions 598-604 may be attached to the base 514 through a combination of alignment pegs which are received in mating apertures and fasteners to connect the leg extensions thereto and provide a secure connection to the table saw 510 while speeding the attachment process thereto. Likewise, the leg extensions and table saw may be configured such that the leg extensions may slide and lock or snap onto the table saw.

Likewise, as illustrated in FIG. 11B, the leg extensions 598-604 are angled slightly outward relative to the vertical axis of the power tool 510 in order to provide the power tool 510 with increased stability when it is in its freestanding configuration. Preferably, the attachment portions of the extensions 598-604 and corner posts 546-552 are sized and positioned to space the leg extensions 598-604 from the bottom of the corner posts 546-552, such that the leg extensions 598-604 are angled slightly outward relative to the vertical as discussed above. The attachment portions are also preferably sized and located such that the leg extensions 598-604 tightly abut the corner posts 546-552, in order to prevent lateral shifting of the leg extensions 598-604 after attachment to the power tool 510.

In a preferred form, the leg extensions 598-604 comprise metal, such as formed sheet metal, aluminum or steel, but the leg extensions 598-604 may alternatively be formed from any other suitable material with sufficient strength and rigidity, such as plastic. The leg extensions 598-604 and feet 562-568 are preferably made interchangeable with their corresponding leg extensions and feet in order to reduce costs associated with independent design, tooling and manufacturing needs and costs, inventory and so forth. For example, by using interchangeable leg extensions 598-604, only one leg extension need be designed, only one set of tooling made, one type of leg extension manufactured and one type of leg extension kept in inventory. Additionally, the interchangeability of the leg extensions 598-604 and feet 562-568 eases the replacement of these parts should any of the leg extensions 598-604 or feet 562-568 be lost or become damaged and allows the operator and/or distributors to keep a limited number of replacement components on hand in preparation for such an occurrence.

While the leg extensions 598-604 described herein are in the form of an accessory which comprises separate components which are attached to the table saw 510, the leg extensions may alternatively be formed integral to the table saw, such that they are able to extend from and retract within the table saw. For example, the leg extensions may be in the form of telescoping extensions which may be extended from the bottom of the table saw, preferably from the bottom of the corner posts, to convert the table saw into its freestanding contractor configuration and retracted into the base of the table saw, preferably into the corner posts, in order to revert the table saw to its bench top configuration.

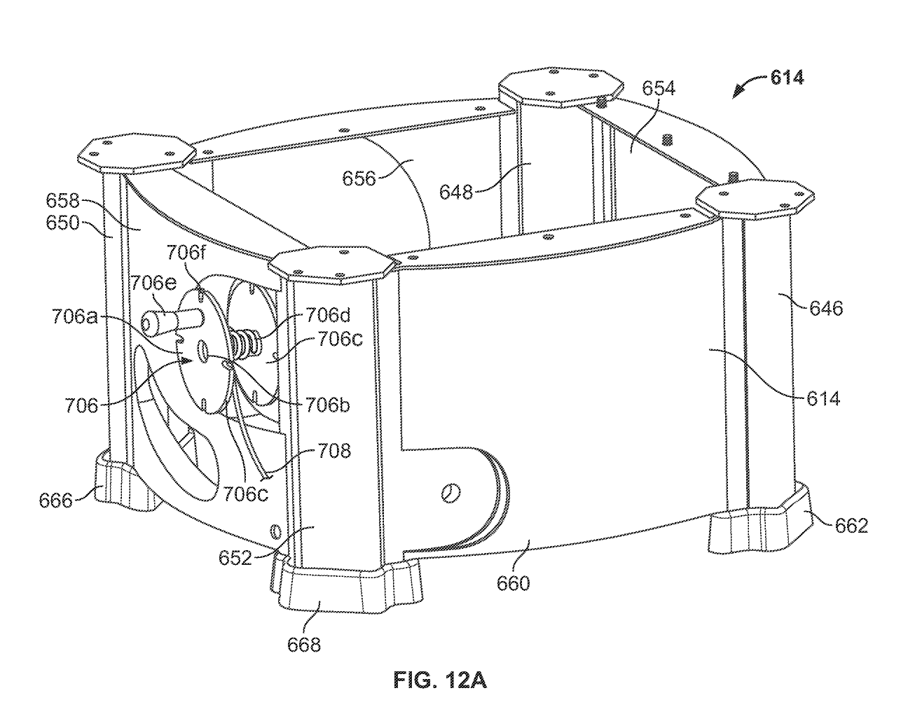

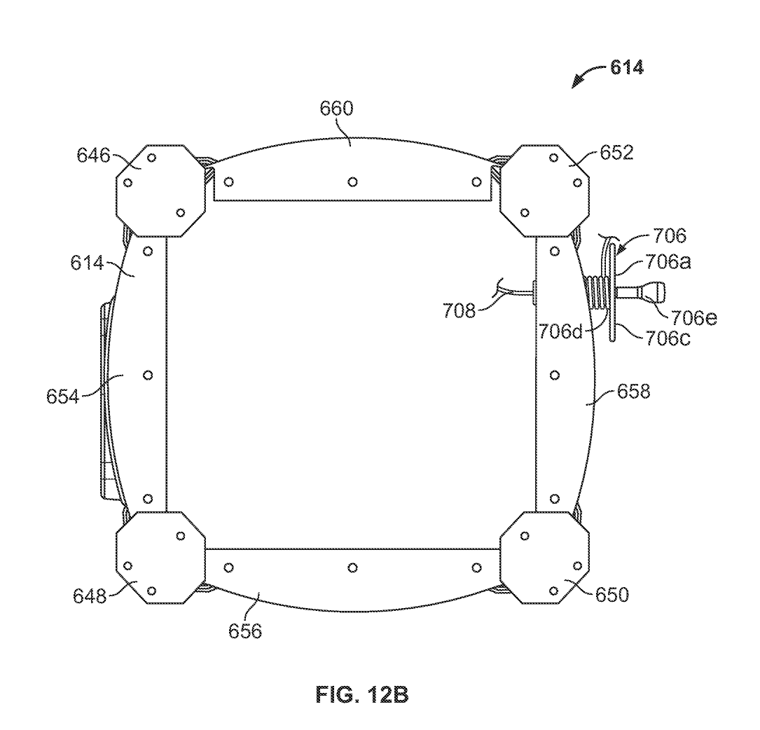

Alternate embodiments of power tools embodying features of the present invention are shown in FIGS. 12A-B and 13A-B and are referred to generally by reference numeral 610. Like the power tools illustrated above, power tool 610 may be a table saw and include the features of any of the embodiments discussed above, including apparatus 10, 110, 210, 310, 410, and 510 discussed above, but is illustrated as a table saw with the table removed therefrom for purposes of clarity. As with the drawing figures discussed above, parts identified in FIGS. 12A-B and 13A-B which are similar to those previously discussed are similarly numbered with the exception of having a prefix “6” in addition to the number used in FIGS. 1A-B or in place of the prefixes used in FIGS. 2A-11E.

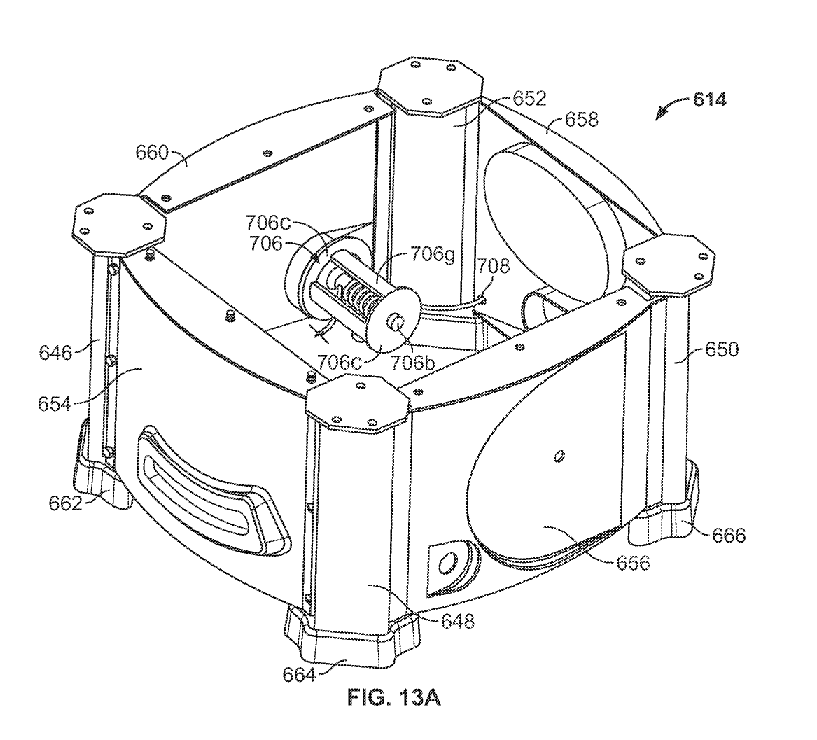

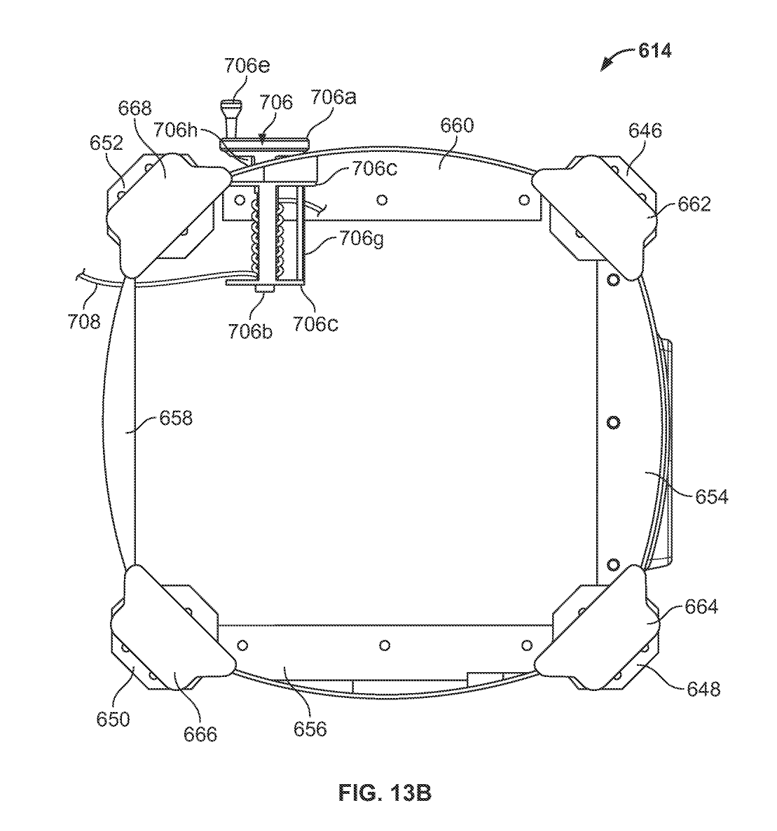

The table saw assembly 610 includes a base 614 having side panels 654, 656, 658 and 660 (collectively “654-660”), a table top 612, corner posts 646, 648, 650, and 652 (collectively “646-652”), and feet 662,664, 666, and 668 (collectively “662-668”). In order to increase the portability and convenience of the power tool, the table saw 610 includes an electrical cord storage system 706 for holding the electrical cord 708 of the table saw 610. The storage system 706 may be an external storage system, as illustrated in FIGS. 12A-B, or an internal storage system, as illustrated in FIGS. 13A-B.

As shown in FIGS. 12A-B, an external cord storage system 706 may include a reel, such as hand wheel 706a, mounted on and capable of rotating about a spindle 706b. The spindle 706b extends through the hand wheel 706a and is attached, or formed integral to, one of the side panels 654-660. The spindle 706b preferably is cylindrical in shape, such that the hand wheel 706a may easily rotate about the spindle 706b.

The hand wheel 706a includes a pair of guides 706c separated by a center portion 706d. The center portion 706d is preferably in the form of a hollow cylinder which surrounds, and may rotate about, the spindle 706b. However, the center portion 706b may have any other hollow shape which allows it to receive the electrical cord 708 thereon. The guides 706c are preferably in the form of thin cylindrical plates and are formed integral to the center portion 706d. The diameter of the guides 706c is selected such that it is significantly greater than the diameter of the center portion 706b. The guides 706c may have a solid configuration, as illustrated in FIGS. 12A-B, or may have a “spoked” configuration. The guides 706c and the center portion 706d are sized such that substantially the entire length of the cord 708 may be rolled up onto and held by the storage system 706.

The hand wheel 706a also includes a handle 706e attached to the outer guide 706c. The handle 706e may be rotatably affixed to the outer guide 706c such that it may rotate about its longitudinal axis, or the handle 706e may be attached to the outer guide 706c in such a way that it does not rotate (for example where the handle 706e is formed integral to the outer guide 706c). The handle 706e is preferably attached to the outer guide 706c at a location which is near the outer perimeter of the guide 706c, such that the operator may easily rotate the hand wheel 706a using the handle 706e. The perimeter of the outer guide 706c of the hand wheel 706a may also include attachment structures, such as slots 706f, to which the plug end, or any other portion, of the cord 708 may be releasably secured.

While the storage system 706 is illustrated as being mounted on side panel 658 in FIGS. 12A-B, the storage system 706 may alternatively be mounted on any of the side panels 654-660. However, it is preferred that the storage system 706 be mounted on one of the side panels 656, 658, and 660, such that is does not interfere with the operation of the table saw 610, while still being in a position in which it may be conveniently accessed. In the embodiment illustrated, the storage system 706 is mounted in a recess defined by side panel 658. The recess allows the hand wheel 706a to remain parallel to the front edge of the table 612 and the other hand wheels or spindles provided on the power tool so that its operation will feel comfortable to the operator and similar in operation to the other hand wheels on the power tool. The side panel 658 may also include a guide structure, such as a extension with a rectangular aperture or an L-shaped structure, for guiding the cord 708 as it is retracted.

In order to operate the storage system 706 and to extend the cord 708 to a suitable electrical outlet, the plug end of the cord 708 is pulled away from the table saw 710, preferably in a direction which is substantially perpendicular to the orientation of the spindle 706b of the hand wheel 706a. As the cord 708 is pulled away from the table saw 710, the hand wheel 706a is allowed to freely rotate, thereby allowing the cord 708 to be unspooled from the center portion 706d of the hand wheel 706a.

Likewise, in order to operate the storage system 706 of FIGS. 12A-B to retract the cord 708 after use, the plug end of the cord 708 is first disconnected from the electrical outlet into which it has been inserted. The operator grasps the handle 706e and rotates the handle 706e about the spindle 706b of the storage system 706, such that the guides 706c and the center portion 706d of the hand wheel 706a begin to rotate about the spindle 706b as well. As the hand wheel 706a rotates, the cord 708 is wrapped around the center portion 706d of the hand wheel 706a. The presence of the guides 706c on either side of the center portion 706d maintains the cord 708 about the center portion 706d. When the cord 708 has been fully retracted, the plug end of the cord 708 may be secured within one of the slots 706f, such that the cord 708 does not become unwound from the hand wheel 706a.

As shown in FIGS. 13A-B, an alternate internal cord storage system 706 may be used which has a structure that is similar to that of the external cord storage system discussed above. The storage system 706 includes a spindle handle or hand wheel 706a affixed to a spindle 706b that extends through one of the side panels 654-660. The spindle 706b preferably has a cylindrical shape and extends through an aperture in the side panel and into the interior of the table saw 610. However, the spindle 706b may alternatively have any other shape which is capable of receiving the electrical cord 708. The spindle 706b extends beyond the inner wall of the side panel a distance which is sufficient to receive the electrical cord 708 thereon, yet does not interfere with or contact the motor or other internal components of the table saw 610.

The spindle 706b is maintained in position by a support structure 706g which is attached to the inside of one of the side panels 654-660 and extends into the interior of the table saw 610. More specifically, the support structure includes an inner wall which is held in place by at least two legs attached to the side panel. The inner wall of the support structure 706g defines an aperture for receiving and holding the spindle 706b in place and allows the spindle 706b to easily rotate. The wall of one of the side panels 654-660 and the inner wall of the support structure 706g preferably cooperate and are configured to operate as guides 706c for guiding the cord 708. The guides 706c, as well as the support structure 706g, preferably have a diameter which is greater than the diameter of the spindle 706b, such that the electrical cord 708 may be received by the spindle 706b without interference by the guides 706c and/or support structure 706g. The guides 706c, spindle 706b, and support structure 706g are sized such that substantially the entire length of the cord 708 may be held within the storage system 706.

The hand wheel 706a has a generally cylindrical shape, preferably with several angled supports 706h which provide a stable connection between the spindle 706b and the hand wheel 706a. The hand wheel 706a may have a substantially solid construction, or may have a “spoked” configuration. The hand wheel 706a also includes a handle 706e attached thereto, generally near the outer perimeter of the hand wheel 706a. The handle 706e is preferably rotatably affixed to the hand wheel 706a such that it may rotate about its longitudinal axis, but alternatively the handle may be attached to the outer guide 706c in such a way that it does not rotate (for example, where the handle 706e is formed integral to the hand wheel 706a).

While the storage system 706 is illustrated as being mounted on the inner surface of side panel 660 in FIGS. 13A-B, the storage system 706 may alternatively be mounted on any of the surfaces of the side panels 654-600. However, preferably the storage system 706 is mounted on one of the side panels 656, 658, and 660 such that it does not interfere with the operation of the table saw 610. The cord 708 preferably extends through an aperture in an adjacent side panel, such as side panel 658 as illustrated, which is sized to be in clearance to the cord 708 but which is sufficiently small to prevent the passage of the plug end of the cord 708 therethrough. Preferably, the aperture is located on the side panel 658 such that the cord 708 extends from the storage system 706 in a direction substantially perpendicular to the longitudinal axis of the spindle 706b. However, the electrical cord may alternatively extend from underneath the side panels 654-660 and the aperture may be omitted.

In order to operate the storage system 706 and to extend the cord 708 to a suitable electrical outlet, the plug end of the cord 708 is pulled away from the table saw 710 and through the aperture in the side panel 658, preferably in a direction which is substantially perpendicular to the orientation of the spindle 706b. As the cord 708 is pulled away from the table saw 710, the hand wheel 706a is allowed to freely rotate, thereby allowing the cord 708 to be unspooled from the spindle 706b.

Likewise, in order to operate the storage system 706 of FIGS. 13A-B to retract the cord 708 after use, the plug end of the cord 708 is disconnected from the electrical outlet into which it has been inserted. The operator grasps the handle 706e and rotates the handle 706e about the spindle 706b of the storage system 706, such that the spindle 706b begins to rotate. As the spindle 706b rotates, the cord 708 is wrapped around the spindle 706b. The presence of the guides 706c, in the form of the wall of the side panel 660 and the inner wall of the support structure 706g, maintains the cord 708 on the section of the spindle 706b which is within the table saw 610. When the cord 708 is wound around the spindle 706b until the plug end of the cord 708 is substantially flush with the aperture of the side panel 658. Optionally, the side panel 658 may include a structure, such as a cord lock, to which the plug end of the cord 708 may be secured when the cord 708 is in its retracted configuration.

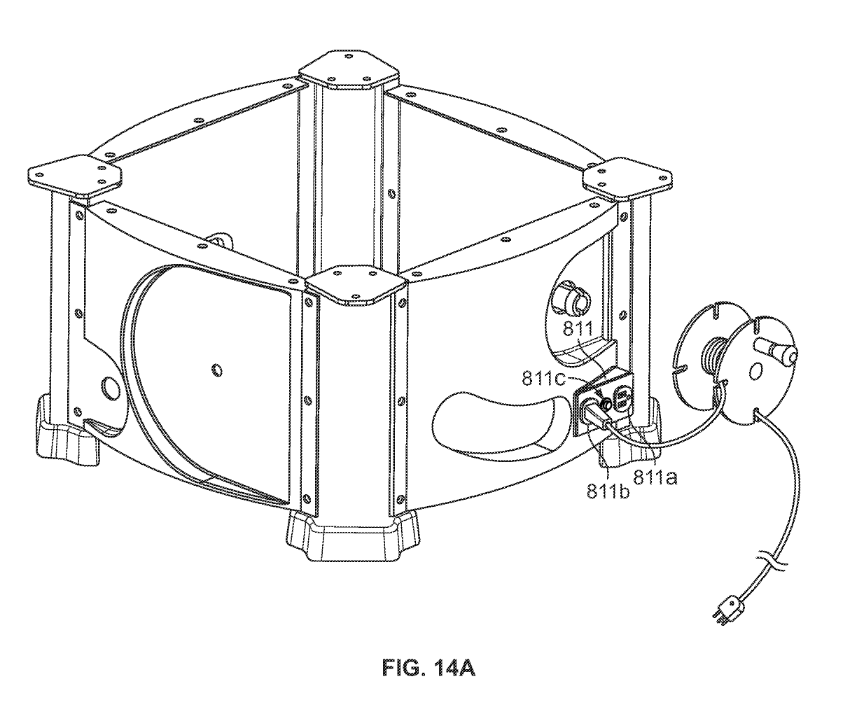

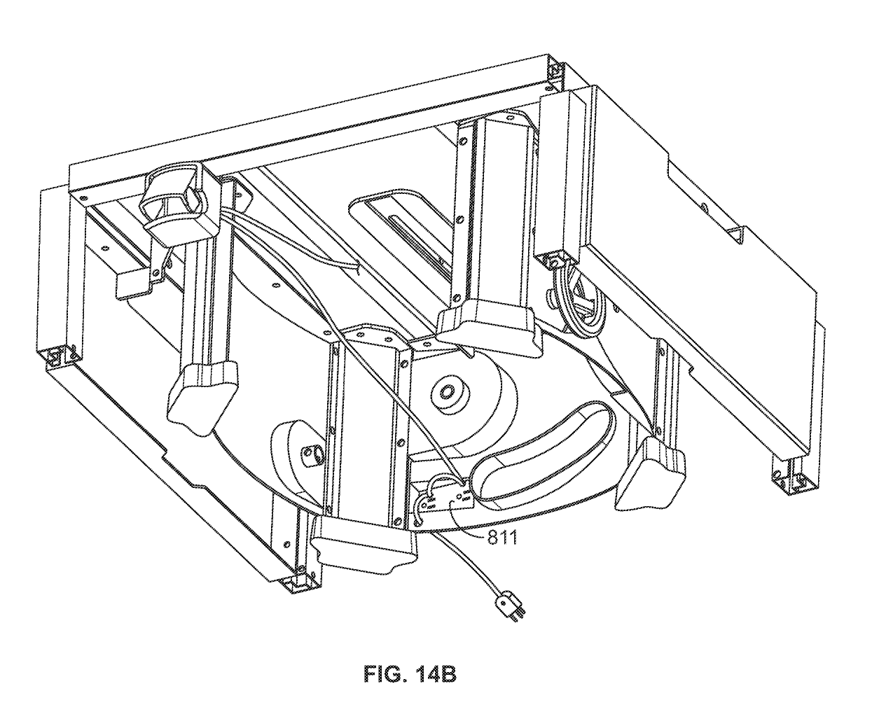

While it is preferred that the storage system 706 be permanently attached to the table saw 610, the storage system may alternatively be of a removable type, such that the storage system 706 and electrical cord 708 may be used as an extension cord in connection with other equipment at the work site. If a removable storage system is to be used, the storage system is preferably an externally-mounted system, such that it may be more easily removed from the table saw. Such an embodiment will be discussed further below with respect to FIGS. 14A-B.

The use of the cord storage system 706, in either its external or internal form, improves the portability and convenience of the table saw 610. That is, when the cord 708 is in its retracted configuration, the operator may move the table saw 610 about the work site or from one work site to another without worrying about stepping on the cord 708 during transit. Thus, the ability of the storage system 706 to effectively hold the entire length, or substantially the entire length, of cord 708 immediately adjacent the table saw 610 substantially increases the ease of moving the table saw 610. Likewise, due to the ability to easily retract the cord 708 into a position which is integral to the table saw 610, the table saw 610 may be provided with a cord 708 which is significantly longer than those provided with conventional table saws, thus reducing the need for extension cords when using the table saw 610 at work sties without nearby electrical outlets.

It should be understood, however, that such a cord retraction system may be used in a variety of power tools. For example, such a retraction system may be used on woodworking or metalworking equipment such as bandsaws, sanders, shapers, formers, drilling and milling machines, mortisers, lathes, jointers and accessories therefor, such as dust collectors and the like. It should also be understood that such a retraction system may be used for items other than cord, such as flexible conduit, hose and the like.

In yet other forms of power tools embodying features of the present invention, the power tool may be designed to include an auxiliary electrical outlet for supplying power to other pieces of equipment. In FIGS. 14A-B, a table saw 810 is illustrated having an electrical outlet 811, which includes at least one receptacle 811a, mounted on one of the side panels, such as side panel 854 of the table saw 810. The table saw 810 may include the features of any of the embodiments previously discussed with respect to apparatus 10, 110, 210, 310, 410, 510 and 610. As with the drawing figures discussed above, parts identified in FIGS. 14A-B which are similar to those previously discussed are similarly numbered with the exception of having a prefix “8” in addition to the number used in FIGS. 1A-B or in place of the prefixes used in FIGS. 2A-13B.

The electrical outlet 811 may be mounted on any of the side panels 854-860 of the table saw 810, however, in a preferred embodiment outlet 811 will be located in the rear panel 858 in order to keep the electrical cords near one another and out of the way of the operator. The electrical outlet 811 is provided so that other smaller portable tools may be plugged directly into the table saw 810 without a need for a separate extension cord running from the tool to the nearest electrical outlet and also to eliminate the possible need for an electrical splitter when multiple tools are used. This may be particularly handy when such tools are used at a worksite where power and/or power outlets are not readily accessible, such as for example, new home and business construction sites.

The electrical outlet 811 preferably includes two receptacles 811a and 811b, such that more than one tool may be plugged into the electrical outlet 811 at the same time. However, the specific number of receptacles included may be adjusted to meet the needs of the operator, while not interfering with the construction of or operation of the table saw 810. The receptacles 811a-b are preferably of the grounded “three-prong” type, so that it may accommodate portable power tools which include either the “three-prong” type plugs or the ungrounded “two-prong” type.

In the embodiment illustrated, the receptacles 811a-b of the electrical outlet are wired to the power supply or electrical cord of the table saw 810, such that the receptacles 811a are powered when the table saw 810 is connected to an electrical outlet via the attached electrical cord of the table saw 810. The receptacles 811a-b of the electrical outlet 811 may be attached to the power supply in any way known in the art. Preferably, the receptacles 811a-b remain powered when the table saw 810 is turned off, but still plugged into the electrical outlet, such that it is unnecessary to run the table saw 810 while using equipment that is plugged into the receptacles 811a-b. The electrical outlet may also optionally include a separate switch for turning the power to the receptacles on and off.

Optionally, the electrical outlet 811 may include structures for protecting the receptacles 811a-b against the entry of fluid, dirt, and debris. For example, the electrical outlet may include a cover which is biased shut, such as the type of outlets commonly used outdoors, to cover the receptacles when not in use or may include sliding covers, such as the type commonly used in “child-proof” electrical outlets, which are biased to cover the receptacles when not in use, but which slide slightly to the side to allow plugs to be inserted into the sockets of the receptacle. The purpose of such structures is to prevent the entry of fluid, dirt, and debris into the interior of the receptacles, since such materials may prevent the electrical plugs from other equipment from being fully inserted therein, creating a potential safety hazard, as well as to increase the durability of the receptacles, particularly when the table saw is used in outdoor applications. In a preferred form, the outlet 811 will include a reset switch 811c which provides over voltage or current protection to the outlet 811 and power tool 810. For example, in FIG. 14A, the reset switch 811c will protect power tool 810 in instances where too much current or voltage is drawn by a load connected to the outlet 811 so that the outlet 811 and power tool 810 do not get damages. If such an event occurs, the breaker will blow causing an open circuit condition to occur and eliminating the outlet's ability to supply power. To reset the outlet 811, the operator will preferably only need to depress the reset switch 811c. In alternate embodiments, however, the reset switch maybe replaced by a fuse that will blow if an over voltage or current condition occurs. To reset such an outlet, the user will have to replace the blown fuse with an operable fuse.

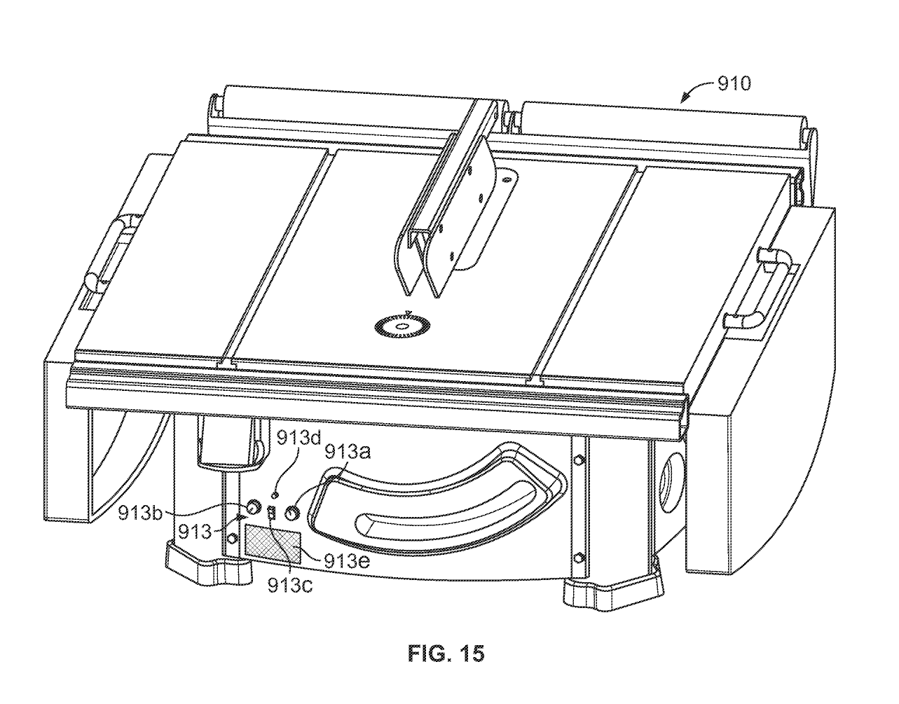

In yet another embodiment, the power tool may be provided with an audio system 913, as illustrated in FIG. 15, to provide music and/or radio programs at the work site. In FIG. 15, the power tool comprises table saw 910 which may include any of the features of the embodiments discussed above with respect to apparatus 10, 110, 210, 310, 410, 51, 610 and 810 discussed above. As with the drawing figures discussed above, parts identified in FIG. 15 which are similar to those previously discussed are similarly numbered with the exception of having a prefix “9” in addition to the number used in FIGS. 1A-B or in place of the prefixes used in FIGS. 2A-14B.

The audio system 913 may be of any type and have the construction of any audio system known in the art and is incorporated into at least one of the side panels of the table saw 910, preferably the front panel 954 of the table saw 910. For example, the audio system may be a radio 913 which includes inputs, such as tuning control knob 913a and volume control knob 913b. The tuning control knob 913a preferably includes a reference thereon, such as a line, arrow, or small projection, and is surrounded by numbers representing the various possible radio frequencies to which the radio 913 may be tuned, such that the operator can determine the station to which the radio 913 has been tuned. Likewise, the volume knob 913b preferably includes some type of reference thereon and is surrounded by numbers, or another type of reference, such that the relative volume of the radio 913 may be determined.

The radio 913 may also include a separate on/off switch, such as switch 913c, although the radio 913 may also be designed to be turned on and off through the operation of the volume control knob 913b. The radio 913 may also include another input, such as a operation mode switch 913d, which may be used to switch the audio player between radio and some other auxiliary mode of operation like a disc player. The operation mode 913d may also be used to switch from one band, such as FM or AM, to another.

The radio 913 also includes some type of small speaker to broadcast the music and/or other radio program at the work site. The speaker may be mounted adjacent the controls for the radio 913, such as speaker 913e mounted on the front panel 954 of the table saw 910, as illustrated in FIG. 15. Alternatively, the speaker, or multiple speakers, may be mounted on other side panels of the table saw 910. Preferably, the speaker 913e includes a durable grill cover to protect the speaker from damage from materials and debris at the work site. The radio 913 also preferably includes an antenna for improving the reception of radio signals. The antenna make take the form of a standard telescoping antenna commonly used with portable radios, or may be incorporated into the structure of the table saw 910 itself (for example, an antenna which is integral to at least one of the corner posts). Preferably, the antenna is mounted in such a way that it does not interfere with the use and operation of the table saw 910.

While it is preferred that the radio 913 be of a type of radio that includes control knobs 913a and 913b, in order to increase the durability of the radio, other types of radios may also be used, such as a radio that includes a digital liquid crystal display for displaying the current station and/or volume and buttons for controlling the volume and tuning of the radio. In any event, the components and controls of the radio 913 are preferably durable, such that they are able to withstand the often rough treatment of the table saw 910 at the work site, as well as possible exposure to debris from the work site and, when used outdoors, possible exposure to the elements.

The radio 913 is preferably powered through the power supply that powers the table saw 910, such as the electrical cord of the table saw 910, so that the radio 913 may be used whenever the table saw 910 is plugged into an electrical outlet. The radio 913 may be wired to the power supply of the table saw 910 in any way known in the art. If the radio 913 is powered through the electrical cord of the table saw 910, the radio 913 preferably is capable of being turned on and used whenever the table saw 910 is plugged in, even when the table saw 910 itself is not being operated. Alternatively, the radio may use an alternative power source, such as batteries, attached thereto.

Although the embodiments discussed above have focused on mobile bench top table saws, it should be understood that the concepts discussed herein may be applied to stationary table saws and other power tools with similar constructions. While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims.

What is claimed is:

1. A power tool for cutting a workpiece, comprising:
a table for supporting a workpiece;
a base for supporting the table;
a cutting implement for cutting the workpiece; and
at least one foldable extension member connected to the power tool and movable between a workpiece supporting position for supporting the workpiece and a stored position for reducing the size of the tool.
